(19) United States
(12) Patent Application Publication
(10) Pub. No.: US 2026/0352854 A1
(43) Pub. Date: Nov. 5, 2026

(54) METHOD AND DEVICE FOR HIERARCHICALLY ADAPTIVE HIGH-LEVEL SYNTAX FOR ARTIFICIAL INTELLIGENCE-BASED POINT CLOUD COMPRESSION

(71) Applicant: Electronics and Telecommunications Research Institute, Daejeon (KR)

(72) Inventors: Jun Sik KIM, Daejeon (KR); Soo Woong KIM, Daejeon (KR); Ji Hoon DO, Daejeon (KR); Gun BANG, Daejeon (KR); Seong Jun BAE, Daejeon (KR); Ha Hyun LEE, Daejeon (KR); Jung Won KANG, Daejeon (KR); Jin Soo CHOI, Daejeon (KR)

(73) Assignee: Electronics and Telecommunications Research Institute, Daejeon (KR)

(21) Appl. No.: 19/577,572

(22) Filed: Mar. 25, 2026

(30) Foreign Application Priority Data
Mar. 25, 2025 (KR) 10-2025-0037753
Mar. 24, 2026 (KR) 10-2026-0052761

(51) Int. Cl. H04N 19/30; H04N 19/119; H04N 19/597; H04N 19/70; H04N 19/96

(52) U.S. Cl. CPC H04N 19/30; H04N 19/119; H04N 19/597; H04N 19/70; H04N 19/96

(57) ABSTRACT

The point cloud data encoding/decoding device, method and recording medium of the present disclosure may include obtaining a bitstream; obtaining hierarchical structure information from the bitstream; and based on the hierarchical structure information, performing decoding on at least one of a precision layer or an attribute layer.

### REFERENCE TO RELEVANT APPLICATION

This application claims priority and benefits on the prior application date for Korean Patent Application No. 10-2025-0037753 filed on Mar. 25, 2025 and Korean Patent Application No. 10-2026-0052761 filed on Mar. 24, 2026, and the contents of the applications are incorporated herein by reference in their entirety.

### TECHNICAL FIELD

The present disclosure relates to a hierarchical adaptive high-level syntax for supporting the encoding/decoding of an individual layer according to precision during artificial intelligence-based point cloud compression.

### BACKGROUND ART

With the rapid development of 3D sensors including a 3D scanner, LiDAR, a vision-based 3D reconstruction technology, etc., the technical field of the 3D graphic content has significantly grown. Furthermore, as a result of sensor-based data collection, a point cloud, which is a raw 3D data format defined by a set of points, has become widely used.

Each point of a point cloud may be expressed in a position by using 3D coordinates. A point cloud is a single set, and may represent the geometry of an object or a scene. Optionally, each point in a point cloud may be connected to a different attribute according to an application. An example may include the RGB color of an immersive application such as VR and AR, the reflectance of LiDAR for autonomous driving and robotics, etc. Point cloud data may enable further processing for more perfect 3D modeling such as mesh expression. In addition, point cloud data may also be directly utilized in a machine-centered follow-up cognitive task such as detection, recognition, etc.

A point cloud may often consist of a series of frames representing a dynamic object or a dynamic scene. In particular, it may correspond to a case for an immersive application such as AR and VR and LiDAR for autonomous driving and robotics. The recent AI technologies have demonstrated cutting-edge performance in the point cloud compression field. However, unlike processing, improvement, rendering and recognition tasks, AI-based point cloud compression has not been widely used due to a lack of standards.

### DISCLOSURE

### Technical Problem

The purpose of the present disclosure is to support encoding/decoding for each precision layer in the AI-PCC compression standard, and more specifically, is to design a high-level syntax that supports layer-adaptive decoding by transmitting the structure information of an individual layer to a decoder according to the precision of a point cloud.

### Technical Solution

The point cloud data encoding/decoding device, method and recording medium of the present disclosure may include obtaining a bitstream; obtaining hierarchical structure information from the bitstream; and based on the hierarchical structure information, performing decoding on at least one of a precision layer or an attribute layer.

In the point cloud data encoding/decoding device, method and recording medium of the present disclosure, the hierarchical structure information may include information indicating a number of layers and information representing the last precision of each layer.

In the point cloud data encoding/decoding device, method and recording medium of the present disclosure, the hierarchical structure information may further include information representing a starting precision and a precision range.

In the point cloud data encoding/decoding device, method and recording medium of the present disclosure, each layer included in the hierarchical structure information may be constructed to correspond to one precision or express a plurality of precision ranges.

In the point cloud data encoding/decoding device, method and recording medium of the present disclosure, the hierarchical structure information may further include hierarchical structure information for attribute data.

In the point cloud data encoding/decoding device, method and recording medium of the present disclosure, the hierarchical structure information for the attribute data may include information representing whether attribute information is present in all precision layers or is present only up to a specific precision layer.

In the point cloud data encoding/decoding device, method and recording medium of the present disclosure, the hierarchical structure information for the attribute data may include information representing the maximum precision and starting precision of attribute information.

In the point cloud data encoding/decoding device, method and recording medium of the present disclosure, the hierarchical structure information may include hierarchical index information corresponding to each layer.

In the point cloud data encoding/decoding device, method and recording medium of the present disclosure, the hierarchical index information may include identification information of a reference layer.

In the point cloud data encoding/decoding device, method and recording medium of the present disclosure, the decoding step may be performed for a portion of all layers.

In the point cloud data encoding/decoding device, method and recording medium of the present disclosure, the decoding step may be performed for a specific attribute layer.

In the point cloud data encoding/decoding device, method and recording medium of the present disclosure, the hierarchical structure information may be included in a data unit header of the bitstream and transmitted.

In the point cloud data encoding/decoding device, method and recording medium of the present disclosure, the hierarchical structure information may be constructed to enable the decoding sequentially according to a hierarchical precision.

### Technical Effect

According to the present disclosure, a function such as scalable compression (scalable coding), hierarchical attribute compression, etc. may be applied by using a hierarchical adaptive high-level syntax, and optimal compression efficiency may be achieved by using hierarchical adaptive compression technologies.

### BRIEF DESCRIPTION OF DRAWINGS

FIG. 1 illustrates an example of a 4-bit binary tree structure storing a voxel.

FIG. 2 illustrates an example of an octree structure for a voxel.

FIG. 3 illustrates an example of the arrangement of a coding unit in a bitstream.

FIG. 4 illustrates an example of the overall decoding process.

FIG. 5 illustrates an example of lossless decoding and lossy decoding in a geometry decoding process.

FIG. 6 illustrates an example of an ancestor occupancy analysis step.

FIG. 7 illustrates an example of a feature decoding step.

FIG. 8 illustrates an example of a sparse 3D convolution-based point synthesis method.

FIG. 9 illustrates an example of an occupancy decoding step.

FIG. 10 illustrates an embodiment of a learning-based motion decoding process.

FIG. 11 illustrates an embodiment of an inter predictor derivation step.

FIG. 12 illustrates an example of a motion compensation step.

FIG. 13 illustrates an example of the overall encoding process.

FIG. 14 illustrates an example of lossless encoding and lossy encoding in a geometry encoding process.

FIG. 15 illustrates an example of a feature encoding step.

FIG. 16 illustrates an example of an occupancy encoding step.

FIG. 17 illustrates an embodiment of a learning-based motion encoding process.

FIG. 18 illustrates an embodiment of an inter predictor derivation step.

FIG. 19 illustrates an example of point cloud data.

FIG. 20 illustrates the hierarchical structure of geometry information according to precision.

FIG. 21 illustrates the structure of an artificial intelligence-based point cloud encoder.

FIG. 22 illustrates the structure of an artificial intelligence-based point cloud decoder.

FIGS. 23 and 24 illustrate an example of a bitstream structure and a high-level syntax of point cloud geometry data.

FIG. 25 illustrates an example of a hierarchical adaptive high-level syntax.

FIG. 26 illustrates an example of a hierarchical adaptive high-level syntax for attribute data.

FIG. 27 illustrates an example of hierarchical index information for transmitting a hierarchical structure.

FIG. 28 illustrates an example of scalable compression using a hierarchical adaptive high-level syntax.

FIG. 29 illustrates an example of attribute data-based scalable compression using a hierarchical adaptive high-level syntax.

### MODE FOR INVENTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in the idea and technical scope of the present disclosure. A similar reference numeral in a drawing refers to a like or similar function across multiple aspects. The shape and size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different from each other, but they do not need to be mutually exclusive. For example, a specific shape, structure and characteristic described herein may be implemented as another embodiment without departing from the scope and spirit of the present disclosure in connection with an embodiment. In addition, it should be understood that the position or arrangement of an individual component in each disclosed embodiment may be changed without departing from the scope and spirit of an embodiment. Accordingly, a detailed description described below is not taken as a limited meaning and the scope of exemplary embodiments, if properly described, is limited only by an accompanying claim along with any scope equivalent to that claimed by those claims.

In the present disclosure, a term such as first, second, etc. may be used to describe a variety of components, but the components should not be limited by the terms. The terms are used only to distinguish one component from other components. For example, without departing from the scope of a right of the present disclosure, the first component may be referred to as the second component and likewise, the second component may be also referred to as the first element. A term of and/or includes a combination of a plurality of relevant described items or any of a plurality of relevant described items.

When a component in the present disclosure is referred to as being “linked” or “connected” to another component, it should be understood that it may be directly linked or connected to that another component, but another component may exist in the middle. On the other hand, when a component is referred to as being “directly linked” or “directly connected” to another component, it should be understood that another component does not exist in the middle.

As construction units shown in the embodiment of the present disclosure are independently shown to represent different characteristic functions, it does not mean that each construction unit is constructed in the construction unit of separate hardware or one software. In other words, as each construction unit is included by being enumerated as each construction unit for convenience of description, at least two construction units of each construction unit may be combined to form one construction unit or one construction unit may be divided into a plurality of construction units to perform a function, and the integrated embodiment and separate embodiment of each construction unit are also included in the scope of a right of the present disclosure unless they are beyond the essence of the present disclosure.

As a term used in the present specification is just used to describe a specific embodiment, it is not intended to limit the present disclosure. Expression of the singular includes expression of the plural unless it clearly has a different meaning contextually. In the present disclosure, it should be understood that a term such as “include” or “have”, etc. is to designate the existence of features, numbers, steps, motions, components, parts or combinations thereof described on the specification, but is not to exclude the existence or possibility of addition of one or more other features, numbers, steps, motions, components, parts or combinations thereof in advance. In other words, a description of “including” a specific configuration in the present disclosure does not exclude a configuration other than a corresponding configuration, and it means that an additional configuration may be included in the scope of a technical idea of the present disclosure or the embodiment of the present disclosure.

Some components of the present disclosure are not a necessary component which performs an essential function in the present disclosure and may be an optional component just for improving performance. The present disclosure may be implemented by including only a construction unit which is necessary to implement essence of the present disclosure except for a component used just for performance improvement, and a structure including only a necessary component except for an optional component used just for performance improvement is also included in the scope of a right of the present disclosure.

Hereinafter, the embodiment of the present disclosure will be described in detail by referring to drawings. In describing the embodiment of the present specification, when it is determined that a detailed description on a relevant disclosed configuration or function may obscure the gist of the present specification, such a detailed description is omitted, and the same reference numeral is used for the same component on a drawing and an overlapping description on the same component is omitted.

The present disclosure discloses the syntax, semantics and decoding process of point cloud data by using an artificial intelligence (AI)-based coding method. In addition, the present disclosure discloses a process necessary for point cloud reconstruction, and discloses additional processes such as a process after decoding, a process before reconstruction, a process after reconstruction, an adaptive process, etc.

The definition of terms used in the present disclosure may be as follows.

Augmented Reality (AR) may be an environment in which the content generated by a computer is superimposed on the real world viewed by a user.

Virtual Reality (VR) is a computer-generated environment in which realistic-looking scenes and objects exist, which makes a user feel immersed in the surrounding environment.

World Coordinate System may be a coordinate system in which a point cloud is captured. A world coordinate system may also be referred to as an original coordinate system.

Coding Coordinate System may be a coordinate system in which a point cloud is coded. In a coding coordinate system, geometry may have a non-negative number.

The definition of abbreviations in the present disclosure may be as follows.

AU: Access Unit

IDR: Instantaneous Decoding Refresh

IRAP: Intra Random Access Point

LSB: Least Significant Bit

MSB: Most Significant Bit

PCC: Point Cloud Compression

AI-PCC: AI-based Point Cloud Compression

Vector<a> may be a vector with a elements.

Matrix<r, c> may be a matrix with r rows and c columns.

Tensor<r, a> may be a sparse tensor designated as a-dimensional vector data for a 3D coordinate list. Here, spatial resolution in each of the x, y and z directions may be between 0 and 2^{r}−1. In addition, parameter a may be the number of feature channels associated with each 3D point.

Concat(T1, T2, T3, . . . ) may be a combination layer connected in a single order in the order that multiple tensors of T1, T2, T3, . . . are shown in a list. Here, all connected tensors must have the same resolution and may have a set of the same points. In addition, each tensor may have a different number of feature channels.

A rectified linear unit (ReLU) is a type of nonlinear activation function used in an artificial neural network, and may be referred to as a rectified linear unit. As an example, the function may output an input value as it is when an input value is greater than a threshold value, but otherwise (when an input value is less than or equal to a threshold value), may output 0.

Conv<a, b, c, d, e> may be a 3D convolution layer whose kernel size is axaxa. Here, b may be a stride parameter, c may be a dilation size, d may be an input channel size, and e may be an output channel size.

Deconv<a, b, c, d, e> may be a 3D deconvolution layer whose kernel size is axaxa. Here, b may be a stride parameter, c may be a dilation size, d may be an input channel size, and e may be an output channel size.

MLP<c₀, c₁, c₂, . . . , cₙ> may be multi-layer perceptrons (MLP) with n layers. Here, c₀ may be the size of an input channel, and cᵢ may be the size of the output channel of each layer (1≤i≤n).

A variable (or a term) related to the point cloud geometry of the present disclosure may be referred to as a point or a voxel. A point explicitly represents the position (x, y, z) of a sample, but may not designate the size of an occupied space. A voxel implicitly represents the position of a sample through a position in an octree and may represent a cube of a specific size. The center of a voxel may be used as the position of a corresponding point.

When point cloud geometry is expressed by points, each point cloud frame may be constructed by an array of 3D positions (x, y, z). Here, the coordinate values of 3D positions may be expressed as a signed integer in a world coordinate system. In addition, the coordinate values of 3D positions may be expressed as an n-bit unsigned integer in the shifted coding coordinate system of the present disclosure. Here, n is a bit depth, and may represent the precision of a point position. In addition, n may be explicitly determined by information signaled from a bitstream or may be implicitly determined by another point cloud-related information. In this case, the size of a 2ⁿ-sized cubic bounding box in which one edge is (0,0,0) and the opposite edge is (2ⁿ⁻¹, 2ⁿ⁻¹, 2ⁿ⁻¹) may be defined in a shifted coding coordinate system.

The scaled coding coordinate system of the present disclosure may be a coordinate system in which a shifted coding coordinate system is scaled to define a scaled coding coordinate system for compression. Whether scaling is applied, the degree of scaling, etc. may be explicitly determined by information signaled from a bitstream or may be implicitly determined by another point cloud-related information.

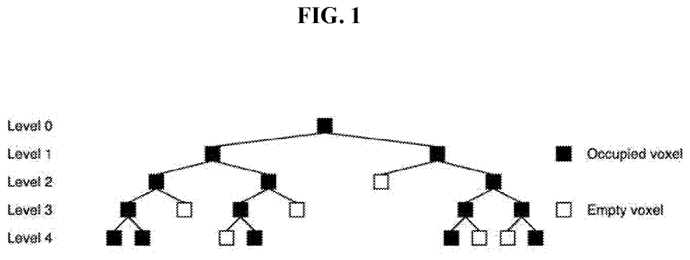

FIG. 1 illustrates an example of a 4-bit binary tree structure storing a voxel.

An octree (or an octree structure) is another method for expressing a point, which may partition a space in a hierarchical way. In point cloud geometry with n-bit coordinates, an octree may have a total of n+1 levels from 0 to n. Here, 0 may represent a root level. An octree which stores a voxel, 3D data, may be a tree structure in which each node has eight children.

Before describing an octree, referring to FIG. 1, since a binary tree structure in FIG. 1 is 4 bits, it may have a total of five levels from 0 to 4. In addition, each node represents a voxel, and an occupied voxel may have two child nodes.

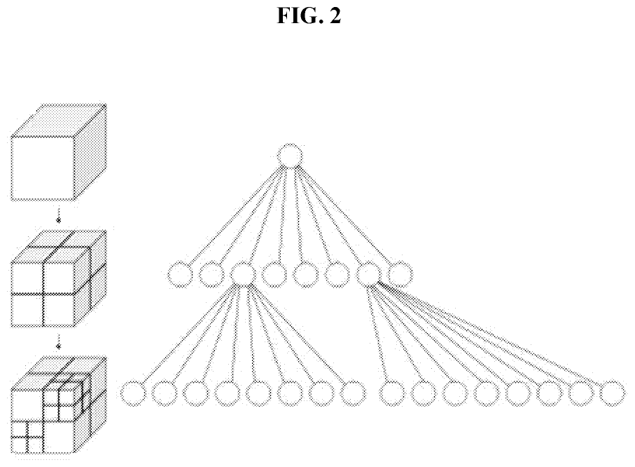

FIG. 2 illustrates an example of an octree structure for a voxel.

In an octree (or an octree structure), for octree level i=0 (a root level), a voxel may occupy the entire space within a point cloud bounding box. For each level, the space of a voxel occupied at a parent level may be equally partitioned in each of the x, y and z directions to generate eight child voxels of the same size. In other words, each child voxel may occupy ⅛ of the parent voxel space. Accordingly, a voxel size is determined according to octree level i to which a corresponding voxel belongs, and when normalized, it may be 2ⁿ⁻ⁱ or 2ⁿ⁻ⁱ/2ⁿ. In the present disclosure, a child voxel may also be expressed as an octant.

In the present disclosure, an occupied voxel may be expressed as a value of 1, and an empty voxel (an unoccupied voxel) may be expressed as a value of 0.

The occupancy map (or voxel occupancy map) Oⁱ of the present disclosure may represent a point cloud for octree level i. In addition, occupancy map Oⁱ may be expressed as Tensor<i, 1>. In this case, the spatial resolution of a tensor may be designated as current octree level i. A one-dimensional value for each point of a tensor may represent whether a voxel is occupied (=1) or empty (=0).

At a specific octree level, a voxelCount variable may be defined as the number of occupied voxels at a parent octree level. The variable may be obtained by a GetVoxelCountParent( ) function which counts the number of occupied voxels at a parent octree level.

The attribute of a point cloud may provide additional information related to each point of a source point cloud. When an attribute exists, each attribute may be connected to the corresponding point of a source point cloud. The attribute type of the present disclosure may include a color and reflectance.

The color attribute of the present disclosure may be expressed in an RGB color space. As an example, each color channel (red, green, blue) may be expressed as an 8-bit unsigned integer value within the range of [0, 255].

When point cloud geometry is expressed as an array of 3D positions (x, y, z), a color attribute may be expressed as an array with an extended field (x, y, z, r, g, b).

When point cloud geometry is expressed as an octree voxel, a color attribute may be expressed as tensor Tensor<n, 3>. Here, n may represent the bit depth of point cloud geometry. A 3D vector for each point of a tensor may represent an associated color value (r, g, b).

When point cloud geometry is expressed as an array of 3D positions (x, y, z), a reflectance attribute may be expressed as an array with an extended field (x, y, z, r). Here, r may represent reflectance.

When point cloud geometry is expressed as an octree voxel, a reflectance attribute may be expressed as tensor Tensor<n, 1>. Here, n may represent the bit depth of point cloud geometry. A one-dimensional scalar for each point of a tensor may represent associated reflectance value r.

The feature of a point cloud may be used as the latent expression of a neural network-based process during point cloud encoding and decoding processes. The feature of a point cloud may be used in a format other than an occupancy map in an encoded point cloud. The feature of a point cloud may not be included in a source point cloud or a decoded point cloud.

A set of features across all voxels within an occupancy map may be referred to as a feature map. At octree level i, a feature map may be expressed as Tensor<j, a>. Here, j represents the spatial resolution of feature map 2^{j}×2^{j}×2^{j}, which may be the same as or different from octree level i. Here, a may represent the number of feature channels.

Each point of a feature map may correspond to an occupied or empty voxel. Each point of a feature map may be associated with an a-dimensional feature vector. Each a-dimensional feature vector may encode geometry information for intra coding. Alternatively, it may encode temporal dynamics and motion patterns for inter prediction coding.

In addition, a feature map may be used for the lossy decoding of an occupancy map or to support lossless decoding.

The points of a point cloud may be ordered in a raster scanning order. Raster scanning may proceed first in a z direction, then in a y direction and finally in an x direction. It may be equivalent to ordering points in ascending order by using key value k calculated based on a point position (x, y, z). In this case, k may be x×2^{r+r}+y×2^{r}+z.

In addition, a raster scanning order may be used to map tensor T to a two-dimensional matrix M=Matrix<N, c> or vice versa.

A point cloud frame may be defined as a complete set of point cloud data representing a 3D scene or object at a specific time point. A point cloud sequence may consist of a series of point cloud frames.

A point cloud frame is partitioned into one or more point cloud slices, and a point cloud slice may be the spatial subunit of a frame. Each slice includes a subset of points within a frame, and generally, may be grouped according to spatial locality, coding efficiency or parallel processing requirements. Encoding of a point cloud frame may be performed by independently encoding each construction slice.

A data coding unit may have four types of a raw coding unit, a feature coding unit, an occupancy coding unit and a motion coding unit. When reproducible coding is enabled, a protection coding unit may be used additionally. All data coding units excluding a raw coding unit may be connected to a protection coding unit. This connection may decode corresponding data in a stable and consistent way, which may be particularly important for compatibility between platforms and a deterministic decoding motion.

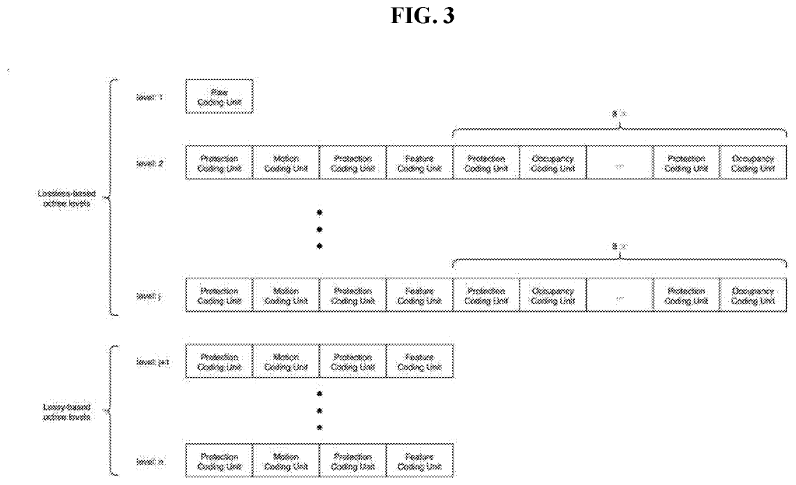

FIG. 3 illustrates an example of the arrangement of a coding unit in a bitstream.

A coding unit may be hierarchically constructed from octree level 1 to the last coded octree level. The last coded octree level may be different from the last octree level of an input point cloud.

At octree level i=0 corresponding to the root node of an octree structure, any data may not be explicitly coded in a bitstream. A root node may be always considered occupied by definition.

For octree level i=1, a raw coding unit may be used to encode the occupancy status of eight octants.

When a raw coding unit is used, 1 byte is used to encode the occupancy of eight octants, and each bit may correspond to one octant.

For octree level 1<i≤j, one feature coding unit may be present in a bitstream for each coded octree level. In addition, each level may encode eight occupancy coding units after encoding one feature coding unit. In other words, a feature coding unit may be used to assist an occupancy coding unit. Here, eight occupancy coding units may correspond to eight octants in a raster scan order ((0,0,0), (1,0,0), (0,1,0), (1,1,0), (0,0,1), (1,0,1), (0,1,1), (1,1,1)).

An occupancy coding unit may include encoded occupancy data representing the occupancy status of a voxel for a specific octant at a current octree level.

Referring to FIG. 3, lossless coded octree levels (or lossless-based octree levels) may represent octree level 1≤i≤j.

Referring to FIG. 3, lossy coded octree levels (or lossy-based octree levels) may represent octree level j<i≤n.

For octree level j<i≤n, each level may need to encode one feature coding unit. In addition, a feature coding unit may be used to derive an occupancy map through a point synthesis process with a lossy coding method. In addition, for lossy coded octree levels, an occupancy coding unit may not exist.

For an inter-coded frame, one motion coding unit must be inserted before a feature coding unit for each coded octree level with i>1.

A protection coding unit may be encoded in a bitstream to protect the decoding of a feature coding unit, an occupancy coding unit and a motion coding unit (all data coding units excluding a raw coding unit). Each protection coding unit is connected to a single data coding unit, and a connected single data coding unit may be a feature coding unit, an occupancy coding unit or a motion coding unit. The role of a protection coding unit may be to protect the reproducibility of related data during decoding. As an example, when protection for crossplatform reproducibility for a specific feature coding unit is enabled, a protection coding unit may be encoded in a bitstream to protect the decoding of the feature coding unit.

A motion coding unit may include encoded motion feature data representing the temporal dynamics between a current frame and a reference frame at a current octree level.

At each inter-coded octree level, one motion coding unit may exist in a bitstream. In addition, as in FIG. 3, a motion coding unit may take precedence over a feature coding unit at the same octree level.

A motion feature may be extracted, quantized and entropy-encoded by an encoder and stored in a bitstream. The motion feature may capture a temporal relationship and a motion pattern between two slices of a current frame and a decoded reference frame, respectively, at a current octree level.

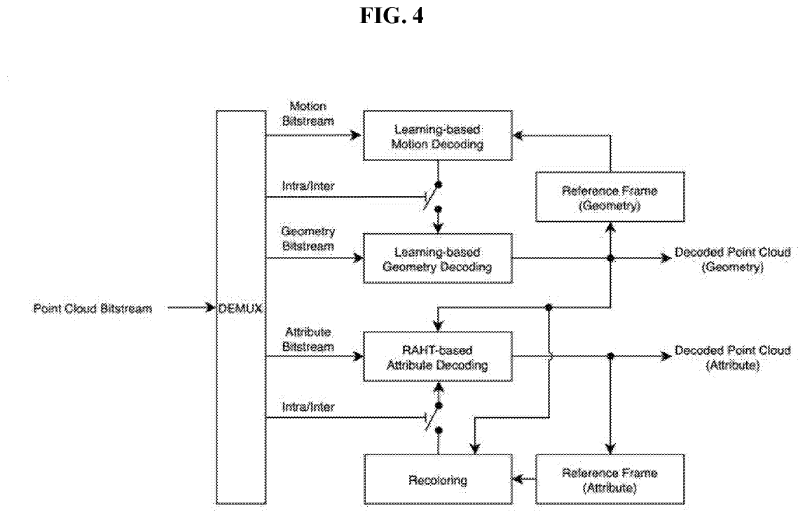

FIG. 4 illustrates an example of the overall decoding process.

The decoding process of the present disclosure may include learning-based point cloud geometry decoding and region adaptive hierarchical transform (RAHT)-based attribute decoding.

Both geometry decoding and attribute decoding may have an intra mode and an inter mode as a decoding mode.

Geometry decoding is neural network-based decoding, and a neural network weight may be obtained according to model identifier information before a geometry decoding process is executed. Here, model identifier information may be information explicitly signaled from a bitstream, information pre-defined in a device or information implicitly determined by other information.

For octree level i=1, eight binary occupancy values may be decoded in a raw coding unit consisting of a single byte. Eight voxels may be arranged in a raster scanning order. The bit of a byte in a raw coding unit may be indexed from the most significant bit (MSB) to the least significant bit (LSB). Each bit may represent the occupancy status of a corresponding voxel. At this level, residual feature

$${{F}^{\text{?}}}_{r}^{1} ,$$

$$\text{?} \text{indicates text missing or illegible when filed}$$

Tensor<0, 8> may be set as a constant dummy feature in which all elements are 1.

For intra point cloud geometry decoding, based on the geometry bitstream of a point cloud, the geometry of a decoded point cloud may be constructed in a learning-based geometry decoding unit. Intra point cloud geometry decoding may be executed per coded octree level, starting from octree level i=2.

For inter point cloud geometry decoding, based on a motion bitstream and a reference frame, geometry predictor information may be generated in a learning-based motion decoding unit. Geometry predictor information may be shared to the learning-based geometry decoding unit of intra decoding as an additional input to construct the geometry of a decoded point cloud in the learning-based geometry decoding unit of intra decoding. Inter point cloud geometry decoding may be executed per coded octree level, starting from octree level i=2.

For intra point cloud attribute decoding, based on an attribute bitstream and decoded point cloud geometry, a decoded point cloud attribute may be constructed in an RAHT-based attribute decoding unit.

For inter point cloud attribute decoding, based on decoded point cloud geometry and an attribute reference frame, attribute predictor information may be generated in a recoloring unit. Attribute predictor information may be shared to the RAHT-based attribute decoding unit of intra decoding as an additional input to construct a decoded point cloud attribute in the RAHT-based attribute decoding unit of intra decoding.

A point cloud geometry intra decoding process (=a geometry intra decoding process) may be invoked per octree level when a current point cloud slice is determined as a geometry intra mode (e.g., when a unit type is determined as Geometry Intra-Slice). Here, a unit type may be explicitly signaled from a bitstream or may be implicitly determined by other information.

In addition, a geometry intra decoding process may be invoked per octree level when a current octree level is greater than a threshold octree level even when a current point cloud slice is determined as a geometry inter mode (e.g., when a unit type is determined as Geometry Inter-Slice). Here, a threshold octree level may be explicitly signaled from a bitstream or may be implicitly determined by other information.

A geometry intra decoding process may be performed in the learning-based geometry decoding unit of FIG. 4.

The unit type of the present disclosure may include types of geometry intra-slice, geometry inter-slice, attribute intra-slice and attribute inter-slice.

The type of a geometry intra decoding process may include lossless-based decoding and lossy-based decoding.

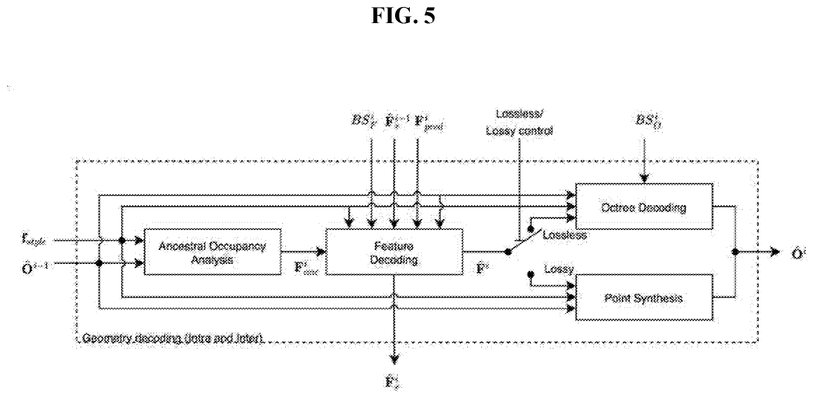

FIG. 5 illustrates an example of lossless decoding and lossy decoding in a geometry decoding process.

A lossy-based decoding process may include 1) an ancestor occupancy analysis step, 2) a feature decoding step and 3) a point synthesis step.

A lossless-based decoding process may include 1) an ancestor occupancy analysis step, 2) a feature decoding step and 4) an octree decoding step.

In other words, in lossy-based and lossless-based decoding processes, 1) an ancestor occupancy analysis step and 2) a feature decoding step may be a common step.

### 1) Ancestor Occupancy Analysis Step

In an ancestor occupancy analysis step, when the occupancy information of the ancestor octree level (i−1, i−2, i−3, i−4) of a current octree level is available, ancestor feature

$${F}_{anc}^{i}$$

may be obtained based on corresponding information.

An ancestor occupancy analysis step may be an initialization step performed before 2) a feature decoding step.

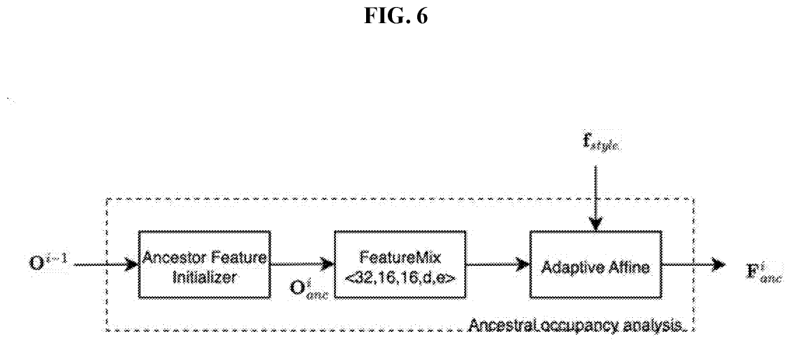

FIG. 6 illustrates an example of an ancestor occupancy analysis step.

An ancestor occupancy analysis step may include an ancestor feature initialization step, a feature mixing step and an adaptive affine step.

An ancestor feature initialization step may obtain ancestor information

$${O}_{anc}^{i} ,$$

which is a 32-dimensional vector, based on the occupancy map Oⁱ⁻¹ of a parent octree level. Here, ancestor information is defined as a connection of [j, p^{j}, o^{j}, v^{j}], and j may be a scalar value representing an octree level index, p may be a 3D vector indicating a 3D position, o may be a 3D vector indicating a binary octant and v may be a scalar value representing a voxel size.

The feature mixing step may be a step for performing a basic neural network-based process for feature aggregation and a channel size transformed from a to c. a and c may be determined through a neural network layer FeatureMix<a, b, c, d, e> in a picture mixing step. As an example, a channel size may be changed from 32 to 16 in the feature mixing step of FIG. 6. All or a part of the parameters used in a feature mixing step may be determined differently based on bit depth-related information.

An adaptive affine step may perform an adaptive affine process that transforms an input feature through learnable affine transform based on style condition f_{style} representing a desired coding motion. An adaptive affine process may be inserted into various processes such as feature extraction, point synthesis, feature encoding, feature decoding, octree encoding, octree decoding, etc. to transform the feature of a corresponding process.

### 2) Feature Decoding Step

In a feature decoding step, based on a feature bitstream for a current octree level

$${BS}_{F}^{i} ,$$

the ancestor feature of a current octree level

$${F}_{anc}^{i} ,$$

a constant dummy prediction feature F_{pred}, the decoded residual feature of a parent octree level

$${{F}^{\text{?}}}_{r}^{i - 1}$$

$$\text{?} \text{indicates text missing or illegible when filed}$$

and the occupancy map of a parent octree level Ôⁱ⁻¹ the decoded feature of a current octree level \hat{F}ⁱ and the decoded residual feature of a current octree level

$${{F}^{\text{?}}}_{r}^{i}$$

$$\text{?} \text{indicates text missing or illegible when filed}$$

may be obtained.

All elements of constant dummy prediction feature F_{pred} may be the same as 1. A constant dummy prediction feature may be used to match geometry feature decoding for intra coding with inter coding.

When there is no feature decoded at a previous level, the decoded residual feature of a parent octree level

$${{F}^{\text{?}}}_{r}^{i - 1}$$

$$\text{?} \text{indicates text missing or illegible when filed}$$

may be set as a dummy feature in which all elements are 1 and used.

A case in which there is no feature decoded at a previous level may include: i) a case in which octree level i=2 is decoded (since a feature is not encoded at octree level i=1) and ii) a case in which the value of a flag indicating that a residual feature is set as a dummy feature for all octree levels for lossless coding is 1.

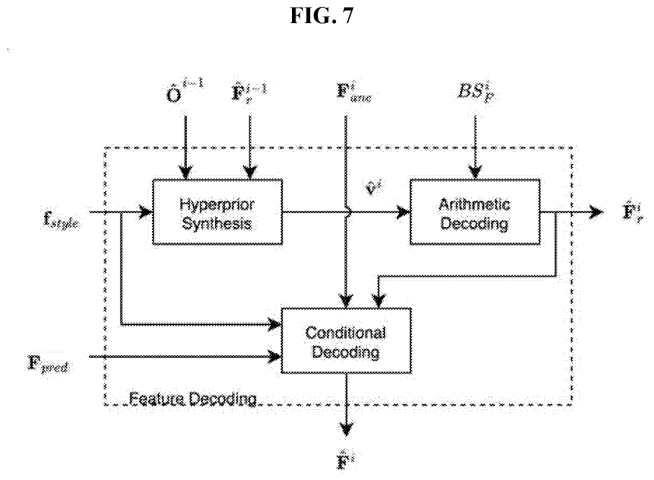

FIG. 7 illustrates an example of a feature decoding step.

A feature decoding step may include a hyper-prior synthesis step, an arithmetic decoding step and a conditional decoding step.

A hyper-prior synthesis step may synthesize a feature variance parameter based on the decoded residual feature of a parent octree level.

An arithmetic decoding step may obtain the decoded residual feature of a current octree level by arithmetic decoding a feature bitstream for a current octree level based on a feature variance parameter obtained in a hyper-prior synthesis step.

A conditional decoding step may conditionally decode the decoded feature of a current octree level by using the ancestor feature and constant dummy prediction feature of a current octree level as a condition and based on the decoded residual feature of a current octree level.

### 3) Point Synthesis Step

In a point synthesis step, based on the decoded feature of a current octree level \hat{F}ⁱ and the decoded occupancy map of a parent octree level, the (lossy) decoded occupancy map of a current octree level may be obtained.

A point synthesis step may be performed for each octree level constructed for lossy-based decoding.

A point synthesis step may be performed in a different way based on a flag representing whether a MultiLayer Perceptron (MLP) is used.

As an example, when a flag representing whether an MLP is used has the first value, a point synthesis step may be performed by a sparse 3D convolution-based point synthesis method, and when a flag representing whether an MLP is used has the second value, a point synthesis step may be performed by an MLP-based point synthesis method.

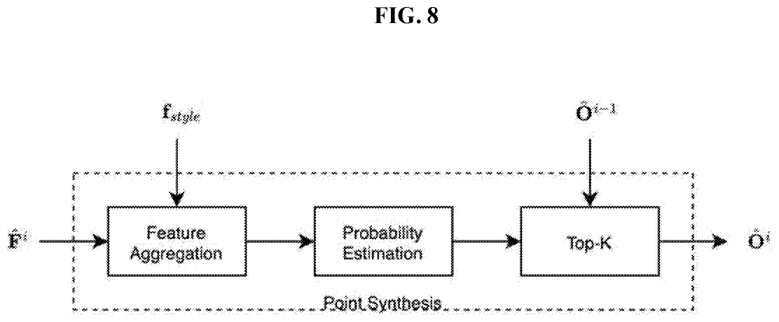

FIG. 8 illustrates an example of a sparse 3D convolution-based point synthesis method.

A sparse 3D convolution-based point synthesis method may have, as an additional input, style condition f_{style} and a parameter representing the number of voxels at a current octree level obtained from a slice geometry header.

A sparse 3D convolution-based point synthesis method may include a feature aggregation step, a probability estimation step and a classification step.

The feature aggregation step of a sparse 3D convolution-based point synthesis method may improve the decoded feature of a current octree level \hat{F}ⁱ and obtain an aggregated and upsampled feature

$${{F}^{\text{?}}}_{0}^{i}$$

$$\text{?} \text{indicates text missing or illegible when filed}$$

by aggregating and upsampling an improved feature.

The probability estimation step of a sparse 3D convolution-based point synthesis method may use aggregated and upsampled feature

$${{F}^{\text{?}}}_{0}^{i}$$

$$\text{?} \text{indicates text missing or illegible when filed}$$

as an input and a multilayer perceptron (MLP) network to calculate the prediction occupancy probability of voxels at a current octree level with one channel. In this case, the channel size of a used MLP layer may be determined differently by bit depth-related information.

The classification step of a sparse 3D convolution-based point synthesis method may order all child voxels (current octree levels) having an occupied parent voxel, and then classify K voxels with the highest occupancy probability as being occupied and the remaining voxels as being empty, thereby obtaining the occupancy map of a current octree level.

An MLP-based point synthesis method may include an offset estimation step, a point construction step and a point clipping and pruning step.

The offset estimation step of an MLP-based point synthesis method may transform the decoded feature of a current octree level \hat{F}ⁱ into a feature with 15 channels, and then consider three consecutive channels as one 3D offset vector, thereby generating five 3D offset vectors for each occupied voxel of a parent octree level.

The point construction step of an MLP-based point synthesis method may generate five 3D points of a current octree level by moving each occupied voxel of a parent octree level according to five 3D offset vectors.

The point clipping and pruning step of an MLP-based point synthesis method may obtain the occupancy map of a current octree level by clipping the coordinates of 3D points and pruning a duplicate point based on the bounding box of a point cloud frame.

### 4) Octree Decoding Step

In an octree decoding step, based on the decoded feature of a current octree level \hat{F}ⁱ, the occupancy map of a parent octree level and the occupancy bitstream of a current octree level, the (lossless) decoded occupancy map of a current octree level may be obtained.

An octree decoding step may be performed for each octree level constructed for lossless-based decoding.

According to bit depth-related information, the mode of an octree decoding step may be determined. The mode of an octree decoding step may include a current level autoregressive mode and a parent level autoregressive mode.

According to a mode, the processes of an octree decoding step may be performed at the resolution of a current octree level or the resolution of a parent octree level.

An octree decoding step may include an initialization step, a feature aggregation step and an occupancy decoding step.

In an initialization step, according to the mode of an octree decoding step, the occupancy map of a parent octree level may be expanded or upsampled to the occupancy map of a current octree level to generate the initial occupancy map of a current octree level O₀ⁱ.

For a current level autoregressive mode, an initialization step may upsample the occupancy map of a parent octree level to the occupancy map of a current octree level to obtain the initial occupancy map of a current octree level

$${O}_{0}^{i} ,$$

Tensor<i, 1>. Ine initial occupancy map of a current octree level has 8×voxelCount (the number of occupied voxels of a parent octree level) points, and all child voxels of an occupied parent voxel may be set as 0.

For a parent level autoregressive mode, an initialization step may expand the occupancy map of a parent octree level to the occupancy map of a current octree level to obtain the initial occupancy map of a current octree level

$${O}_{0}^{i} ,$$

Tensor<i−1, 8>. An initialization step may the initial occupancy map of a current octree level initialize all channels to 0 and repeat the channel of Oⁱ⁻¹ 8 times to generate

$${O}_{0}^{i} .$$

The eight child voxels are mapped to eight channels in which indexes from 0 to 7 are designated, and the order may be (0,0,0), (1,0,0), (0,1,0), (1,1,0), (0,0,1), (1,0,1), (0,1,1), (1,1,1).

In a feature aggregation step, based on the decoded feature of a current octree level \hat{F}ⁱ, an aggregated feature

$${{F}^{\text{?}}}_{0}^{i}$$

$$\text{?} \text{indicates text missing or illegible when filed}$$

according to a mode may be obtained.

For a current level autoregressive mode, a feature aggregation step may improve the decoded feature of a current octree level \hat{F}ⁱ and obtain an aggregated feature

$${{F}^{\text{?}}}_{0}^{i}$$

$$\text{?} \text{indicates text missing or illegible when filed}$$

by aggregating and upsampling an improved feature.

For a parent level autoregressive mode, a feature aggregation step may obtain an aggregated feature

$${{F}^{\text{?}}}_{0}^{i}$$

$$\text{?} \text{indicates text missing or illegible when filed}$$

by aggregating the decoded feature of a current octree level \hat{F}ⁱ without changing resolution (having the resolution of a parent octree level).

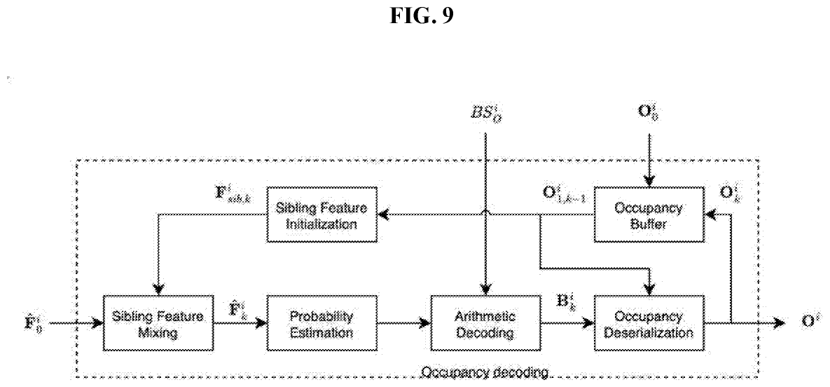

FIG. 9 illustrates an example of an occupancy decoding step.

An occupancy decoding step may be invoked 8 times repeatedly to decode the occupancy map of octree level i. k representing the numbering of repetitions may have a range from 1 to 8. A repetition for eight octants may follow the order of (0,0,0), (1,0,0), (0,1,0), (1,1,0), (0,0,1), (1,0,1), (0,1,1), (1,1,1).

An occupancy decoding step for the kth repetition may be performed by i) an occupancy buffer, ii) a sibling feature initialization unit, iii) a sibling feature mixing unit, iv) a probability estimation unit, v) an arithmetic decoding unit and vi) an occupancy deserialization unit.

### i) Occupancy Buffer

An occupancy buffer may store and provide all sibling occupancy maps decoded in the previous repetition of a current octree level

$${O}_{1 , k - 1}^{i}$$

(from 1 to k−1) to be referenced in the next decoding repetition. In addition, it may also manage a mask which is a decoding mask representing whether a child voxel is decoded. In addition, for the first repetition (k=1), an occupancy buffer may be initialized.

### ii) Sibling Feature Initialization Unit

In a sibling feature initialization unit, an initial sibling feature

$${{F}^{\text{?}}}_{sib , k}^{i}$$

$$\text{?} \text{indicates text missing or illegible when filed}$$

may be obtained by initializing a feature based on all sibling occupancy maps decoded in a previous repetition

$${O}_{1 , k - 1}^{i} .$$

For a current level autoregressive mode, a sibling feature initialization unit may obtain an initial sibling feature

$${{F}^{\text{?}}}_{sib , k}^{i}$$

$$\text{?} \text{indicates text missing or illegible when filed}$$

by performing initialization with a five-dimensional vector. In this case, one dimension may represent a scalar value for an octree level, three dimensions may represent a scalar value at a 3D position and one dimension may represent the binary value of a decoding mask map.

For a parent level autoregressive mode, a sibling feature initialization unit may obtain an initial sibling feature

$${{F}^{\text{?}}}_{sib , k}^{i}$$

$$\text{?} \text{indicates text missing or illegible when filed}$$

by performing initialization in the same way as an input

$${O}_{L , k - 1}^{i} .$$

iii) Sibling Feature Mixing Unit

In a sibling feature mixing unit, an aggregated feature

$${{F}^{\text{?}}}_{0}^{i}$$

$$\text{?} \text{indicates text missing or illegible when filed}$$

and an initial sibling feature

$${{F}^{\text{?}}}_{sib , k}^{i}$$

$$\text{?} \text{indicates text missing or illegible when filed}$$

may be mixed to obtain a mixed feature

$${{F}^{\text{?}}}_{k}^{i} .$$

$$\text{?} \text{indicates text missing or illegible when filed}$$

The mixing process of a sibling feature mixing unit may be different according to whether a mode is a current level autoregressive mode or a parent level autoregressive mode.

### iv) Probability Estimation Unit

A probability estimation unit may predict the occupancy probability

$${p}_{k}^{i}$$

of voxels of a current octree level for each occupied parent voxel based on a mixed feature

$${{F}^{\text{?}}}_{k}^{i} .$$

$$\text{?} \text{indicates text missing or illegible when filed}$$

For a current level autoregressive mode, a probability estimation unit may use a multilayer perceptron (MLP) network to predict the occupancy probability

$${p}_{k}^{i}$$

of voxels of a current octree level with one channel. In this case, the channel size of a used MLP layer may be determined differently by bit depth-related information.

For a parent level autoregressive mode, a probability estimation unit may predict the occupancy probability

$${p}_{k}^{i}$$

of voxels of a current octree level by using a convolution layer, an ReLU layer and an Inception ResNet (IRN) layer.

### v) Arithmetic Decoding Unit

An arithmetic decoding unit may obtain the sequence of a binary value

$${B}_{k}^{i}$$

based on an occupancy bitstream and a prediction probability for the current octant of a current octree level.

### vi) Occupancy Deserialization Unit

An occupancy deserialization unit may obtain the occupancy map

$${O}_{k}^{i}$$

of a current repetition by using the decoded occupancy map

$${O}_{k - 1}^{i}$$

and binary sequence

$${B}_{k}^{i}$$

of a previous repetition. An occupancy status may be set as 1 and unoccupied may be set as 0. After all eight repetitions, the decoded occupancy map of a current octree level Oⁱ may be set as a combination of

$${O}_{1}^{i} , {O}_{2}^{i} , … , {O}_{8}^{i} .$$

A point cloud geometry inter decoding process may be invoked per octree level when a current point cloud slice is signaled as a geometry inter mode (=a unit type is signaled as Geometry Inter-Slice) and a current octree level is less than or equal to a threshold octree level.

A point cloud geometry inter decoding process may be performed by a combination of a learning-based geometry decoding unit, a learning-based motion decoding unit and a reference frame unit in FIG. 4.

A point cloud geometry inter decoding process may include a motion decoding process and a main decoding process.

In a motion decoding process, a predictor for a current frame may be obtained based on a motion between a reference frame and a current frame. It may correspond to the learning-based motion decoding unit and a reference frame unit of FIG. 4.

In a main decoding process, geometry decoding may be performed based on a predictor for a current frame. It may correspond to the learning-based geometry decoding unit of FIG. 4.

A global motion compensation process may be invoked as a preprocessing process at every octree level before invoking an inter decoding process.

The input and output of a global motion compensation process may belong to a shifted coding coordinate system.
1) First, the coordinates of each point in a reference point cloud frame Ĝ_{ref} may be transformed based on the point cloud boundary box center (c, c, c). This transform may be performed by Ĝ_{ref}=Ĝ_{ref}−(c,c,c)^{t}. The position of the boundary box center in a shifted coding coordinate system may be defined as in c=2^{sps_geometry_bit_depth_minus1}.
2) Next, a reference point cloud frame Ĝ_{ref} may be transformed as in Ĝ_{ref}=R×Ĝ_{ref}+T by using rotation matrix R and motion vector T designated by the fps_transform_matrix array of a bitstream.
3) Lastly, a global motion compensation reference frame may be obtained by applying inverse transform to move a reference point cloud frame Ĝ_{ref} back to a shifted coding coordinate system. This inverse transform may be performed by Ĝ_{ref}=Ĝ_{ref}+(c,c,c)^{t}.

Unless there are special circumstances, when gps_global_motion_flag is the same as 1, the reference point cloud geometry of the present disclosure may be interpreted as a global motion compensation reference point cloud.

A learning-based motion decoding process performed in a learning-based motion decoding unit may be invoked for each octree level for a slice at the start of a point cloud geometry inter decoding process.

A learning-based motion decoding process may generate a predicted feature to support a main decoding process.

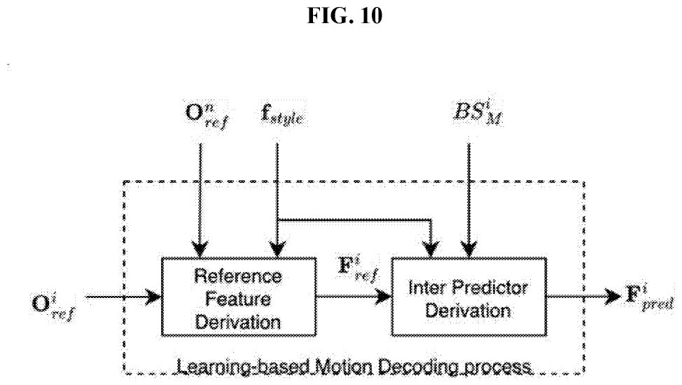

FIG. 10 illustrates an embodiment of a learning-based motion decoding process.

A learning-based motion decoding process may include a reference feature derivation step and an inter predictor derivation step.

A reference feature derivation step may obtain the reference feature of a current octree level by using a style condition and the decoded occupancy map of a current octree level. In addition, when a flag representing whether a MultiLayer Perceptron (MLP) is used is the first value, the occupancy map of a previous octree level may be additionally used to obtain the reference feature of a current octree level.

FIG. 11 illustrates an embodiment of an inter predictor derivation step.

An inter predictor derivation step may include a motion feature buffer management step, a hyper-prior synthesis step, an arithmetic decoding step and a motion compensation step.

A motion feature buffer management step may store and provide a decoded motion feature. As an example, a motion feature buffer management process may provide the decoded motion feature of a parent octree level to a hyper-prior synthesis step for a current octree level.

A hyper-prior synthesis step may synthesize a feature variance parameter by using the motion feature of a parent octree level. A hyper-prior synthesis step may operate in the same manner as a hyper-prior synthesis step described above. However, an input may be the decoded motion feature of a parent octree level instead of the decoded residual feature of a parent octree level.

An arithmetic decoding step may operate in the same manner as an arithmetic decoding step described above. However, an input bitstream may be substituted with a motion bitstream. In other words, an arithmetic decoding step may obtain the decoded motion feature of a current octree level by arithmetic decoding a motion bitstream based on a feature variance parameter obtained in a hyper-prior synthesis step.

In a motion compensation step, the prediction feature

$${F}_{pred}^{i}$$

of a current octree level may be obtained based on the decoded motion feature of a current octree level, the reference feature of a current octree level and a style condition.

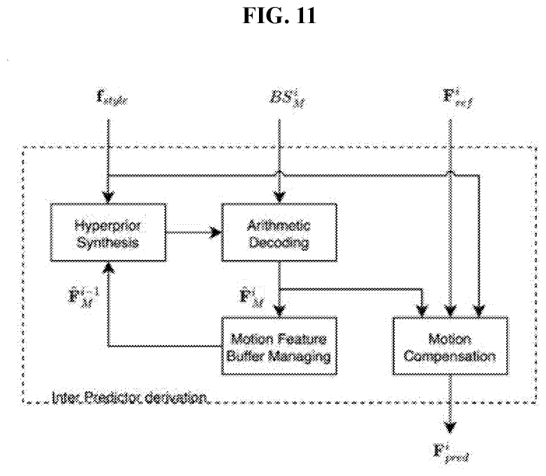

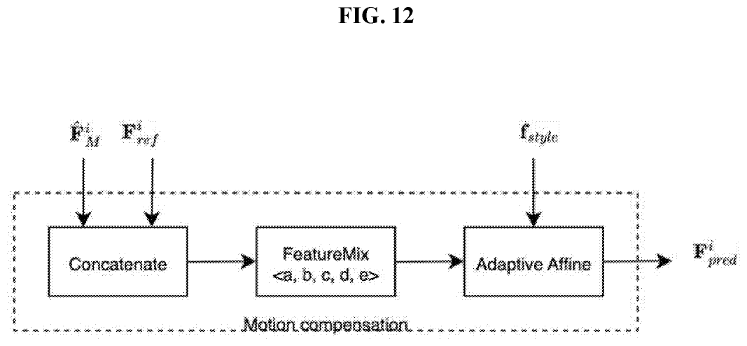

FIG. 12 illustrates an example of a motion compensation step.

A main decoding process may be invoked at each octree level of a slice after a learning-based motion decoding process is completed.

A main decoding process is performed in the learning-based geometry decoding unit of FIG. 4, and a corresponding unit may be a neural network shared with a geometry intra decoding process.

Similar to a geometry intra decoding process, the type of a main decoding process may include lossless-based decoding and lossy-based decoding.

Compared to a geometry intra decoding process, a difference in a main decoding process may be using a prediction feature generated in a learning-based motion decoding process instead of a dummy feature.

A lossy-based decoding process may include 1) an ancestor occupancy analysis step, 2) a feature decoding step and 3) a point synthesis step.

A lossless-based decoding process may include 1) an ancestor occupancy analysis step, 2) a feature decoding step and 4) an octree decoding step.

In other words, in lossy-based and lossless-based decoding processes, 1) an ancestor occupancy analysis step and 2) a feature decoding step may be a common step.

### 1) Ancestor Occupancy Analysis Step

In an ancestor occupancy analysis step, when the occupancy information of the ancestor octree level (i−1, i−2, i−3, i−4) of a current octree level is available, an ancestor feature

$${F}_{anc}^{i}$$

may be obtained based on corresponding information.

In an ancestor occupancy analysis step, when the occupancy information of the ancestor octree level (i−1, i−2, i−3, i−4) of a current octree level is available, an ancestor feature

$${F}_{anc}^{i}$$

may be obtained based on corresponding information.

An ancestor occupancy analysis step may include an ancestor feature initialization step, a feature mixing step and an adaptive affine step. Since the specific details of each step of an ancestor occupancy analysis step are described above, they are omitted below.

### 2) Feature Decoding Step

Based on a feature bitstream for a current octree level

$${BS}_{F}^{i} ,$$

the ancestor feature of a current octree level

$${F}_{anc}^{i}$$

In a feature decoding step, the prediction feature of a current octree level

$${F}_{pred}^{i} ,$$

the decoded residual feature of a parent octree level

$${{F}^{\text{?}}}_{r}^{i - 1}$$

$$\text{?} \text{indicates text missing or illegible when filed}$$

and the occupancy map of a parent octree level Ôⁱ⁻¹, the decoded feature of a current octree level \hat{F}ⁱ and the decoded residual feature of a current octree level

$${{F}^{\text{?}}}_{r}^{i}$$

$$\text{?} \text{indicates text missing or illegible when filed}$$

may be obtained.

### 3) Point Synthesis Step

In a point synthesis step, based on the decoded feature of a current octree level \hat{F}ⁱ and the occupancy map of a parent octree level, the (lossy) decoded occupancy map of a current octree level may be obtained.

A point synthesis step may be performed for each octree level constructed for lossy-based decoding.

A point synthesis step may be performed in a different way based on a flag representing whether a MultiLayer Perceptron (MLP) is used.

As an example, when a flag representing whether an MLP is used has the first value, a sparse 3D convolution-based point synthesis method may be performed, and when a flag representing whether an MLP is used has the second value, an MLP-based point synthesis method may be performed. Since the specific details of a point synthesis step are described above, they are omitted below.

### 4) Octree Decoding Step

In an octree decoding step, based on the decoded feature of a current octree level \hat{F}ⁱ and the occupancy map of a parent octree level, the (lossless) decoded occupancy map of a current octree level may be obtained.

An octree decoding step may be performed for each octree level constructed for lossless-based decoding.

According to bit depth-related information, the mode of an octree decoding step may be determined. The mode of an octree decoding step may include a current level autoregressive mode and a parent level autoregressive mode.

Since the specific details of an octree decoding step are described above, they are omitted below.

Region adaptive hierarchical transform (RAHT)-based attribute decoding may include intra point cloud attribute decoding and inter point cloud attribute decoding.

For intra point cloud attribute decoding, based on an attribute bitstream and decoded point cloud geometry, a decoded point cloud attribute may be obtained in an RAHT-based attribute decoding unit.

For inter point cloud attribute decoding, based on decoded point cloud geometry and an attribute reference frame, attribute predictor information may be generated in an attribute predictor generation unit. As an example, when an attribute is a color, attribute predictor information may be generated in a recoloring unit. Attribute predictor information may be shared to the RAHT-based attribute decoding unit of intra decoding as an additional input to obtain a decoded point cloud attribute in the RAHT-based attribute decoding unit of intra decoding.

After a point cloud geometry slice is decoded, whether to perform an inverse scaling process may be determined based on a coordinate transform flag representing that point cloud geometry is transformed from a world coordinate system to a coding coordinate system and scaling ratio information representing the amount of scaling from a shifted coding coordinate system to a scaled coding coordinate system.

As an embodiment, an inverse scaling process may be performed when a coordinate transform flag is 1 and the amount of scaling of scaling ratio information is less than 1.

In an inverse scaling process, based on decoded point cloud geometry Ĝ which is a set of 3D point positions of a coding coordinate system and a scaling coefficient specified by scaling ratio information, unscaled point cloud geometry which is a set of 3D point positions of a shifted coding coordinate system may be obtained.

In addition, based on inverse scaling type information representing the type of an inverse scaling process, an inverse scaling process may be performed by a simple inverse scaling process or an improved inverse scaling process.

An inverse scaling process may be invoked when a point cloud geometry slice is decoded and a coordinate transform flag is a value equal to 1. In addition, when scaling ratio information represents a value less than 1, an inverse transform process may be additionally invoked after an inverse scaling process is completed.

An inverse transform process may move the point cloud geometry of a shifted coding coordinate system back to a world coordinate system.

When assembly process-related information represents that a point cloud frame is partitioned into slices and coded individually, an assembly process is invoked after all point cloud slices are decoded, and may obtain a point cloud frame by assembling all decoded point cloud slices.

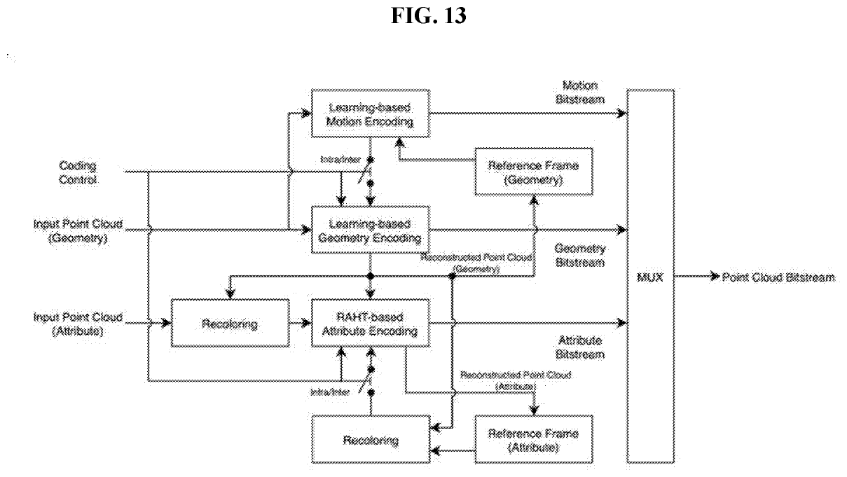

FIG. 13 illustrates an example of the overall encoding process.

The encoding process of the present disclosure may include learning-based point cloud geometry encoding and region adaptive hierarchical transform (RAHT)-based attribute encoding.

Both geometry encoding and attribute encoding may have an intra mode and an inter mode as an encoding mode.

Geometry encoding is neural network-based encoding, and a neural network weight may be determined before a geometry encoding process is executed. Model identifier information representing a neural network weight may be encoded directly or indirectly into a bitstream. Alternatively, a neural network weight may be a pre-defined value between an encoder and a decoder.

For octree level i=1, eight binary occupancy values may be encoded in a raw coding unit consisting of a single byte. Eight voxels may be arranged in a raster scanning order. The bit of a byte in a raw coding unit may be indexed from the most significant bit (MSB) to the least significant bit (LSB). Each bit may represent the occupancy status of a corresponding voxel. At this level, a residual feature, Tensor<0, 8> may be set as a constant dummy feature in which all elements are 1.

For intra point cloud geometry encoding, the geometry of an encoded point cloud may be constructed in a learning-based geometry encoding unit and encoded in a bitstream. Intra point cloud geometry encoding may be executed per each octree level, starting from octree level i=2.

For inter point cloud geometry encoding, geometry predictor information may be generated in a learning-based motion encoding unit and a motion bitstream may be encoded based on geometry predictor information and a reference frame. Geometry predictor information may be shared to the learning-based geometry encoding unit of intra encoding as an additional input to construct the geometry of an encoded point cloud in the learning-based geometry encoding unit of intra encoding. Inter point cloud geometry encoding may be executed per each octree level, starting from octree level i=2.

For intra point cloud attribute encoding, an encoded point cloud attribute may be constructed in an RAHT-based attribute encoding unit and an attribute bitstream may be encoded based on an encoded point cloud attribute and encoded point cloud geometry.

For inter point cloud attribute encoding, based on encoded point cloud geometry and an attribute reference frame, attribute predictor information may be generated in a recoloring unit. Attribute predictor information may be shared to the RAHT-based attribute encoding unit of intra encoding as an additional input to construct an encoded point cloud attribute in the RAHT-based attribute encoding unit of intra encoding and encode an attribute bitstream based on an encoded point cloud attribute.

The specific details of an encoding process may correspond to the specific details of a decoding process.

A (geometry) transform process may be invoked as a preprocessing step. A transform process may transform a point cloud in a world coordinate system into a shifted coding coordinate system. Later, a decoder may perform a process for transforming an output back into a world coordinate system.

After a transform process is completed, whether to perform a (geometry) scaling process may be determined based on a coordinate transform flag representing that point cloud geometry is transformed from a world coordinate system to a coding coordinate system and scaling ratio information representing the amount of scaling from a shifted coding coordinate system to a scaled coding coordinate system.

As an embodiment, a scaling process may be performed when a coordinate transform flag is 1 and the amount of scaling of scaling ratio information is less than 1.

In a scaling process, based on point cloud geometry Ĝ which is a set of 3D point positions of a shifted coding coordinate system and a scaling coefficient specified by scaling ratio information, the scaled point cloud geometry of a shifted coding coordinate system may be obtained.

A point cloud geometry intra encoding process (=a geometry intra encoding process) may be invoked per octree level when a current point cloud slice is determined as a geometry intra mode (e.g., when a unit type is determined as Geometry Intra-Slice).

In addition, a geometry intra encoding process may be invoked per octree level when a current octree level is greater than a threshold octree level even when a current point cloud slice is determined as a geometry inter mode (e.g., when a unit type is determined as Geometry Inter-Slice). Here, a threshold octree level may be encoded directly or indirectly into a bitstream.

A geometry intra encoding process may be performed in the learning-based geometry encoding unit of FIG. 13.

The unit type of the present disclosure may include types of geometry intra-slice, geometry inter-slice, attribute intra-slice and attribute inter-slice.

The type of a geometry intra encoding process may include lossless-based encoding and lossy-based encoding.

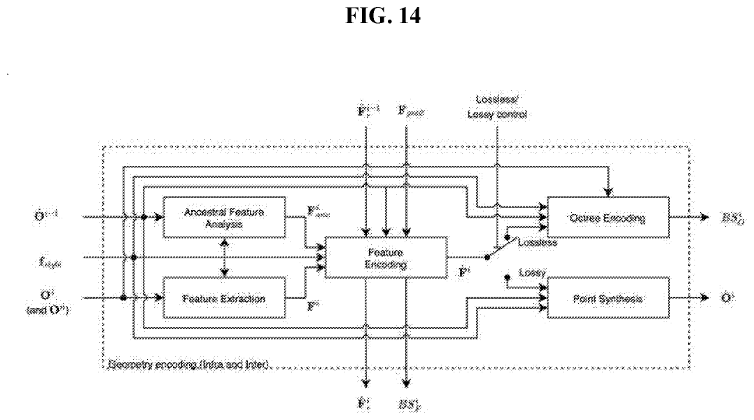

FIG. 14 illustrates an example of lossless encoding and lossy encoding in a geometry encoding process.

A lossy-based encoding process may include 1) an ancestor occupancy analysis step, 2) a feature extraction step, 3) a feature encoding step and 4) a point synthesis step.

A lossless-based encoding process may include 1) an ancestor occupancy analysis step, 2) a feature extraction step, 3) a feature encoding step and 5) an octree encoding step.

In other words, in lossy-based and lossless-based encoding processes, 1) an ancestor occupancy analysis step, 2) a feature extraction step and 3) a feature encoding step may be a common step.

### 1) Ancestor Occupancy Analysis Step

In an ancestor occupancy analysis step, when the occupancy information of the ancestor octree level (i−1, i−2, i−3, i−4) of a current octree level is available, ancestor feature

$${F}_{anc}^{i}$$

may be obtained based on corresponding information.

An ancestor occupancy analysis step may be an initialization step performed before 3) a feature encoding step.

An ancestor occupancy analysis step may include an ancestor feature initialization step, a feature mixing step and an adaptive affine step. Since the specific details of each step are the same as those in a geometry decoding process, they are omitted below.

### 2) Feature Extraction Step

Based on the voxel occupancy map Oⁱ of the current octree level of an input point cloud and a style condition f_{style}, a feature Fⁱ representing the local geometry information of the current octree level of an input point cloud may be obtained.

A feature extraction step may be performed in a different way based on a flag representing whether a MultiLayer Perceptron (MLP) is used.

As an example, when a flag representing whether an MLP is used has the first value, the voxel occupancy map Oⁿ of the parent octree level of an input point cloud may be provided as an additional input.

As an example, when a flag representing whether an MLP is used has the second value, a sparse 3D convolution-based feature extraction method may be performed.

### 3) Feature Encoding Step

In a feature encoding step, based on a feature Fⁱ representing geometry information about a current octree level, the ancestor feature of a current octree level

$${F}_{anc}^{i} ,$$

a constant dummy prediction feature F_{pred} and the decoded residual feature of a parent octree level

$${{F}^{\text{?}}}_{r}^{i - 1} ,$$

$$\text{?} \text{indicates text missing or illegible when filed}$$

a feature bitstream

$${BS}_{F}^{i}$$

for a current octree level, the decoded feature of a current octree level \hat{F}ⁱ and the decoded residual feature of a current octree level

$${{F}^{\text{?}}}_{r}^{i}$$

$$\text{?} \text{indicates text missing or illegible when filed}$$

may be obtained.

All elements of constant dummy prediction feature F_{pred} may be the same as 1. A constant dummy prediction feature may be used to match geometry feature encoding for intra coding with inter coding.

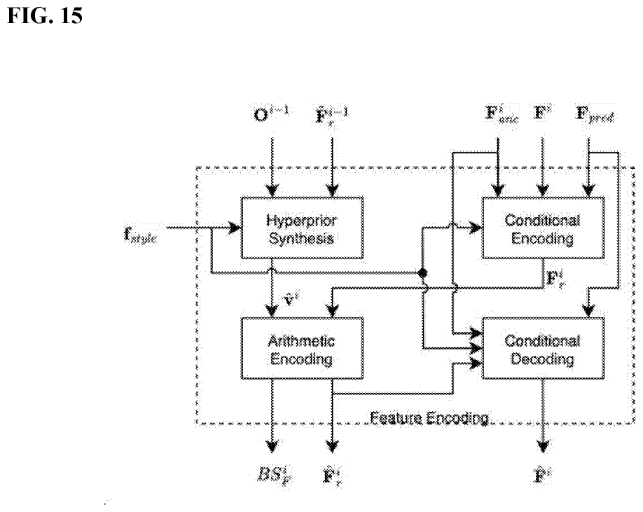

FIG. 15 illustrates an example of a feature encoding step.

A feature encoding step may include a hyper-prior synthesis step, a conditional encoding step, an arithmetic encoding step and a conditional decoding step.

A hyper-prior synthesis step may synthesize a feature variance parameter based on the decoded residual feature of a parent octree level.

A conditional encoding step may conditionally encode the feature of a current octree level by using the ancestor feature and constant dummy prediction feature of a current octree level as a condition and based on the residual feature of a current octree level.

An arithmetic encoding step may obtain the decoded residual feature and feature bitstream of a current octree level based on a feature variance parameter obtained in a hyper-prior synthesis step and the residual feature of a current octree level.

A conditional decoding step may conditionally decode the decoded feature of a current octree level by using the ancestor feature and constant dummy prediction feature of a current octree level as a condition and based on the decoded residual feature of a current octree level.

### 4) Point Synthesis Step

In a point synthesis step, based on the decoded feature of a current octree level \hat{F}ⁱ and the occupancy map of a parent octree level, the (lossy) decoded occupancy map of a current octree level may be obtained.

A point synthesis step may be performed in a different way based on whether a MultiLayer Perceptron (MLP) is used.

As an example, when an MLP is used, a sparse 3D convolution-based point synthesis method may be performed, and when an MLP is not used, an MLP-based point synthesis method may be performed.

Information representing whether an MLP is used may be encoded in a bitstream.

Since the specific details of a sparse 3D convolution-based point synthesis method and an MLP-based point synthesis method are described above, they are omitted below.

### 5) Octree Encoding Step

In an octree encoding step, based on the decoded feature of a current octree level \hat{F}ⁱ, the occupancy map of a parent octree level and the occupancy map of a current octree level, an occupancy bitstream for a current octree level

$${BS}_{0}^{i}$$

may be obtained.

An octree encoding step may be performed for each octree level constructed for lossless-based encoding.

According to bit depth-related information, the mode of an octree encoding step may be determined. The mode of an octree encoding step may include a current level autoregressive mode and a parent level autoregressive mode.

According to a mode, the intermediate processes of an octree encoding step may be performed at the resolution of a current octree level or the resolution of a parent octree level.

An octree encoding step may include an initialization step, a feature aggregation step and an occupancy encoding step.

In an initialization step, according to the mode of an octree encoding step, the occupancy map of a parent octree level may be expanded or upsampled to the occupancy map of a current octree level to generate the initial occupancy map of a current octree level

$${O}_{0}^{i} .$$

For a current level autoregressive mode, an initialization step may upsample the occupancy map of a parent octree level to the occupancy map of a current octree level to obtain the initial occupancy map of a current octree level

$${O}_{0}^{i} ,$$

Tensor<i, 1>. The initial occupancy map of a current octree level has 8×voxelCount (the number of occupied voxels of a parent octree level) points, and all child voxels of an occupied parent voxel may be set as 0.

For a parent level autoregressive mode, an initialization step may expand the occupancy map of a parent octree level to the occupancy map of a current octree level to obtain the initial occupancy map of a current octree level

$${O}_{0}^{i} ,$$

Tensor<i−1, 8>. An Initialization step may initialize all channels to 0 and repeat the channel of Oⁱ⁻¹ 8 times to generate

$${O}_{0}^{i} .$$

The eight child voxels are mapped to eight channels in which indexes from 0 to 7 are designated, and the order may be (0,0,0), (1,0,0), (0,1,0), (1,1,0), (0,0,1), (1,0,1), (0,1,1), (1,1,1).

In a feature aggregation step, the decoded feature of a current octree level \hat{F}ⁱ may be improved to obtain an aggregated feature

$${\hat{F}}_{0}^{i}$$

according to a mode.

For a current level autoregressive mode, a feature aggregation step may improve the decoded feature of a current octree level \hat{F}ⁱ and obtain an aggregated feature

$${\hat{F}}_{0}^{i}$$

by aggregating and upsampling an improved feature.

For a parent level autoregressive mode, a feature aggregation step may obtain an aggregated feature

$${\tilde{F}}_{0}^{i}$$

by aggregating the decoded feature of a current octree level \hat{F}ⁱ without changing resolution (having the resolution of a parent octree level).

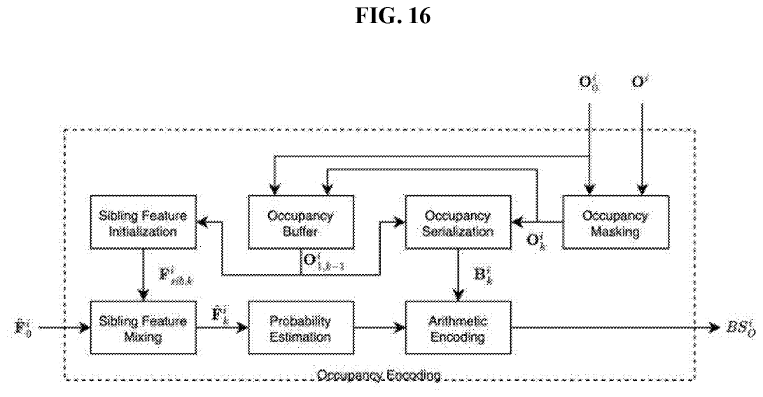

FIG. 16 illustrates an example of an occupancy encoding step.

An occupancy encoding step may be invoked 8 times repeatedly to encode the occupancy map of octree level i. k representing the numbering of repetitions may have a range from 1 to 8. A repetition for eight octants may follow the order of (0,0,0), (1,0,0), (0,1,0), (1,1,0), (0,0,1), (1,0,1), (0,1,1), (1,1,1).

An occupancy encoding step for the kth repetition may be performed by i) an occupancy buffer, ii) a sibling feature initialization unit, iii) a sibling feature mixing unit, iv) a probability estimation unit, v) an occupancy masking unit, vi) an occupancy serialization unit and vii) an arithmetic encoding unit.

### i) Occupancy Buffer

An occupancy buffer may store and provide all sibling occupancy maps decoded in the previous repetition of a current octree level

$${O}_{1 , k - 1}^{i}$$

(from 1 to k−1) to be referenced in the next decoding repetition. In addition, it may also manage a mask which is a decoding mask representing whether a child voxel is decoded. In addition, for the first repetition (k=1), an occupancy buffer may be initialized.

### ii) Sibling Feature Initialization Unit

In a sibling feature initialization unit, an initial sibling feature

$${\tilde{F}}_{sib , k}^{i}$$

may be obtained by initializing a feature based on all sibling occupancy maps decoded in a previous repetition

$${O}_{1 , k - 1}^{i} .$$

For a current level autoregressive mode, a sibling feature initialization unit may obtain an initial sibling feature

$${\hat{F}}_{sib , k}^{i}$$

by performing initialization with a five-dimensional vector. In this case, one dimension may represent a scalar value for an octree level, three dimensions may represent a scalar value at a 3D position and one dimension may represent the binary value of a decoding mask map.

For a parent level autoregressive mode, a sibling feature initialization unit may obtain an initial sibling feature

$${\hat{F}}_{sib , k}^{i}$$

by performing initialization in the same way as an input
iii) Sibling Feature Mixing Unit

$${O}_{1 , k - 1}^{i} .$$

In a sibling feature mixing unit, an aggregated feature

$${\hat{F}}_{0}^{i}$$

and an initial sibling feature

$${\hat{F}}_{sib , k}^{i}$$

may be mixed to obtain a mixed feature

$${\hat{F}}_{k}^{i} .$$

The mixing process of a sibling feature mixing unit may be different according to whether a mode is a current level autoregressive mode or a parent level autoregressive mode.

### iv) Probability Estimation Unit

In a probability estimation unit, based on a mixed feature

$${F}_{k}^{i} ,$$

the occupancy probability

$${p}_{k}^{i}$$

of voxels of a current octree level may be predicted for each occupied parent voxel.

For a current level autoregressive mode, a probability estimation unit may use a multilayer perceptron (MLP) network to predict the occupancy probability

$${p}_{k}^{i}$$

of voxels of a current octree level with one channel. In this case, the channel size of a used MLP layer may be determined differently by bit depth-related information.

For a parent level autoregressive mode, a probability estimation unit may predict the occupancy probability

$${p}_{k}^{i}$$

of voxels of a current octree level by using a convolution layer, an ReLU layer and an Inception ResNet (IRN) layer.

### v) Occupancy Masking Unit

The kth occupancy map

$${O}_{k}^{i}$$

of a current repetition may be obtained based on the upsampled occupancy map

$${O}_{0}^{i}$$

of a current octree lever based on a parent octree level.

### vi) Occupancy Serialization Unit

In an occupancy serialization unit, a binary sequence

$${B}_{k}^{i}$$

may be obtained based on the occupancy map

$${O}_{k}^{i}$$

or a current repetition.
vii) Arithmetic Encoding Unit

In an arithmetic encoding unit, an occupancy bitstream may be generated by encoding the sequence of a binary value

$${B}_{k}^{i}$$

by using a prediction probability for the current octant of a current octree level.

A point cloud geometry inter encoding process may be invoked per octree level when a current point cloud slice is determined as a geometry inter mode (=a unit type is determined as Geometry Inter-Slice) and a current octree level is less than or equal to a threshold octree level.

A point cloud geometry inter encoding process may be performed by a combination of a learning-based geometry encoding unit, a learning-based motion encoding unit and a reference frame unit in FIG. 13.

A point cloud geometry inter encoding process may include a motion encoding process and a main encoding process.

In a motion encoding process, a motion between a reference frame and a current frame may be estimated and a predictor for a current frame may be obtained. It may correspond to the learning-based motion encoding unit and a reference frame unit of FIG. 13.

In a main encoding process, geometry encoding may be performed based on a predictor for a current frame. It may correspond to the learning-based geometry encoding unit of FIG. 13.

A global motion evaluation and compensation process may be invoked as a preprocessing process at every octree level before invoking an inter encoding process.

The input and output of a global motion evaluation and compensation process may belong to a shifted coding coordinate system.
1) First, the coordinates of each point in a current point cloud frame G_{curr} and a reference point cloud frame G_{ref} may be transformed based on the point cloud boundary box center (c, c, c). This transform may be performed by G_{curr}=G_{curr}−(c,c,c)^{t} and G_{ref}=G_{ref}−(c,c.c)^{t}.

The position of the boundary box center in a shifted coding coordinate system may be defined as in c=2^{sps_geometry_bit_depth_minus1}.
2) Next, a global motion expressed as rotation matrix R and motion vector T may be determined, and a reference point cloud frame G_{ref} may be transformed as in G_{ref}=R×G_{ref}+T by using rotation matrix R and motion vector T.
3) Lastly, a global motion compensation reference frame may be obtained by applying transform to move a reference point cloud frame G_{ref} back to a shifted coding coordinate system. This transform may be performed by G_{ref}=G_{ref}+(c,c,c)^{t}.

A learning-based motion encoding process performed in a learning-based motion encoding unit may be invoked for each octree level for a slice at the start of a point cloud geometry inter decoding process.

A learning-based motion encoding process may generate a predicted feature to support a main encoding process.

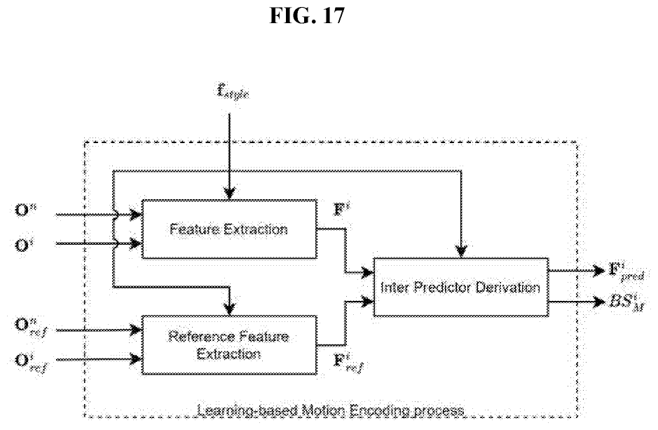

FIG. 17 illustrates an embodiment of a learning-based motion encoding process.

A learning-based motion encoding process may include a feature derivation step, a reference feature derivation step and an inter predictor derivation step.

A feature derivation step may obtain the feature of a current octree level by using a style condition and the occupancy map of a current octree level. In addition, when a MultiLayer Perceptron (MLP) is used, the current occupancy map of a previous octree level may be additionally used to obtain the feature of a current octree level.

A reference feature derivation step may obtain the reference feature of a current octree level based on a style condition and the reference occupancy map of a reference point cloud for a current octree level. In addition, when a MultiLayer Perceptron (MLP) is used, the reference occupancy map of the reference point cloud of a previous octree level may be additionally used to obtain the reference feature of a current octree level.

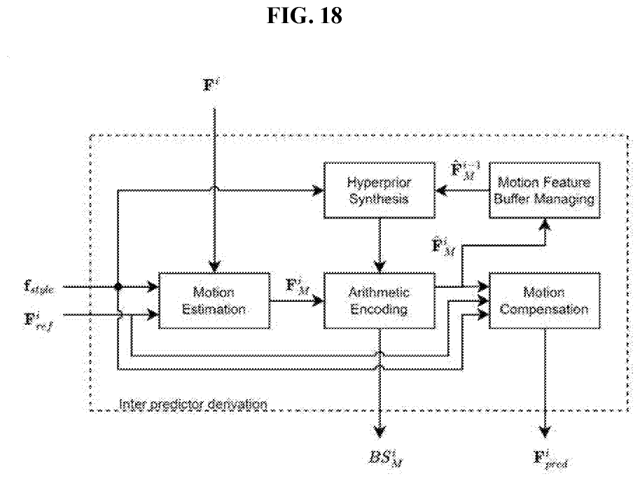

FIG. 18 illustrates an embodiment of an inter predictor derivation step.

An inter predictor derivation step may include a motion feature buffer management step, a hyper-prior synthesis step, a motion evaluation step, an arithmetic encoding step and a motion compensation step.

A motion feature buffer management step may store and provide a decoded motion feature. As an example, a motion feature buffer management process may provide the decoded motion feature of a parent octree level to a hyper-prior synthesis step for a current octree level.

A hyper-prior synthesis step may synthesize a feature variance parameter by using the motion feature of a parent octree level. A hyper-prior synthesis step may operate in the same manner as a hyper-prior synthesis step described above. However, an input may be the decoded motion feature of a parent octree level instead of the decoded residual feature of a parent octree level.

In a motion evaluation step, the motion feature of a current octree level may be obtained based on the feature of the current point cloud of a current octree level, the reference feature of the reference point cloud of a current octree level and a style condition.

An arithmetic encoding step may operate in the same manner as an arithmetic encoding step described above. However, the residual feature of an input current octree level may be substituted with the motion feature of a current octree level. In other words, an arithmetic encoding step may obtain a motion bitstream by arithmetic encoding the motion feature of a current octree level based on a feature variance parameter obtained in a hyper-prior synthesis step.

In a motion compensation step, the prediction feature

$${F}_{pred}^{i}$$

of a current octree level may be obtained based on the decoded motion feature of a current octree level, the reference feature of a current octree level and a style condition.

A main encoding process may be invoked at each octree level of a slice after a learning-based motion encoding process is completed.

A main encoding process is performed in the learning-based geometry encoding unit of FIG. 13, and a corresponding unit may be a neural network shared with a geometry intra encoding process.

Similar to a geometry intra encoding process, the type of a main encoding process may include lossless-based encoding and lossy-based encoding.

Compared to a geometry intra encoding process, a difference in a main encoding process may be using a prediction feature generated in a learning-based motion encoding process instead of a dummy feature.

A lossy-based encoding process may include 1) an ancestor occupancy analysis step, 2) a feature extraction step, 3) a feature encoding step and 4) a point synthesis step.

A lossless-based encoding process may include 1) an ancestor occupancy analysis step, 2) a feature extraction step, 3) a feature encoding step and 5) an octree encoding step.

In other words, in lossy-based and lossless-based encoding processes, 1) an ancestor occupancy analysis step, 2) a feature extraction step and 3) a feature encoding step may be a common step.

### 1) Ancestor Occupancy Analysis Step

In an ancestor occupancy analysis step, when the occupancy information of the ancestor octree level (i−1, i−2, i−3, i−4) of a current octree level is available, ancestor feature

$${F}_{anc}^{i}$$

may be obtained based on corresponding information.

An ancestor occupancy analysis step may be an initialization step performed before 3) a feature encoding step.

An ancestor occupancy analysis step may include an ancestor feature initialization step, a feature mixing step and an adaptive affine step. Since the specific details of each step are the same as those in a geometry decoding process, they are omitted below.

### 2) Feature Extraction Step

Based on the voxel occupancy map Qⁱ of the current octree level of an input point cloud and a style condition f_{style}, a feature Fⁱ representing the local geometry information of the current octree level of an input point cloud may be obtained.

A feature extraction step may be performed in a different way based on whether a MultiLayer Perceptron (MLP) is used.

As an example, when an MLP is used, the voxel occupancy map Oⁿ of the parent octree level of an input point cloud may be provided as an additional input.

As an example, when an MLP is not used, a sparse 3D convolution-based feature extraction method may be performed.

### 3) Feature Encoding Step

In a feature encoding step, based on a feature Fⁱ representing geometry information about a current octree level, the ancestor feature of a current octree level

$${F}_{anc}^{i} ,$$

the prediction feature of a current octree level

$${F}_{pred}^{i}$$

and the decoded residual feature of a parent octree level

$${\hat{F}}_{r}^{i - 1} ,$$

a feature bitstream BS_{F}ⁱ for a current octree level, the decoded feature of a current octree level \hat{F}ⁱ and the decoded residual feature of a current octree level

$${\hat{F}}_{r}^{i}$$

may be obtained.

### 4) Point Synthesis Step

In a point synthesis step, based on the decoded feature of a current octree level \hat{F}ⁱ and the occupancy map of a parent octree level, the (lossy) decoded occupancy map of a current octree level may be obtained.

A point synthesis step may be performed in a different way based on whether a MultiLayer Perceptron (MLP) is used.

As an example, when an MLP is used, a sparse 3D convolution-based point synthesis method may be performed, and when an MLP is not used, an MLP-based point synthesis method may be performed. Since the specific details of each method are described above, they are omitted below.

### 5) Octree Encoding Step

In an octree encoding step, based on the decoded feature of a current octree level \hat{F}ⁱ, the occupancy map of a parent octree level and the occupancy map of a current octree level, an occupancy bitstream for a current octree level

$${BS}_{0}^{i}$$

may be obtained.

An octree encoding step may be performed for each octree level constructed for lossless-based encoding.

According to bit depth-related information, the mode of an octree encoding step may be determined. The mode of an octree encoding step may include a current level autoregressive mode and a parent level autoregressive mode.

According to a mode, the intermediate processes of an octree encoding step may be performed at the resolution of a current octree level or the resolution of a parent octree level.

An octree encoding step may include an initialization step, a feature aggregation step and an occupancy encoding step.

Since the specific details of an octree encoding step are described above, they are omitted below.

Region adaptive hierarchical transform (RAHT)-based attribute encoding may include intra point cloud attribute encoding and inter point cloud attribute encoding.

For intra point cloud attribute encoding, based on an input point cloud attribute and encoded point cloud geometry, an attribute bitstream may be encoded in an RAHT-based attribute encoding unit.

For inter point cloud attribute encoding, based on restored point cloud geometry and an attribute reference frame, attribute predictor information may be generated in an attribute predictor generation unit. As an example, when an attribute is a color, attribute predictor information may be generated in a recoloring unit. Attribute predictor information may be shared to the RAHT-based attribute encoding unit of intra encoding as an additional input to obtain an attribute bitstream in the RAHT-based attribute encoding unit of intra encoding.

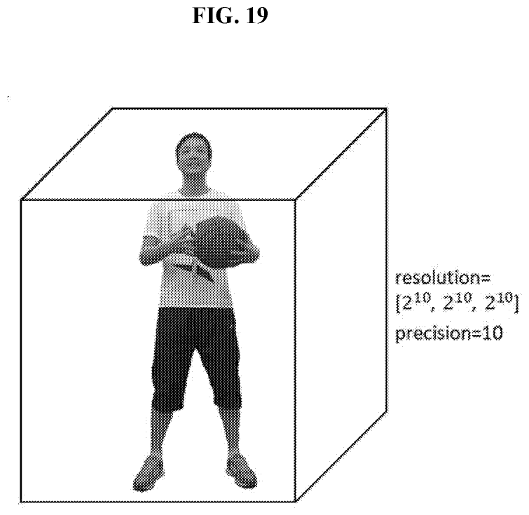

FIG. 19 illustrates an example of point cloud data.

The point cloud of the present disclosure is composed of a set of points having a three-dimensional coordinate value, and each point may represent a structure including geometry information and attribute information. Attribute information may include a color, reflectance, transparency, a normal vector, a spherical harmonic function, etc. Such point cloud data may be obtained through various sensors such as LiDAR, an RGB-D camera, etc.

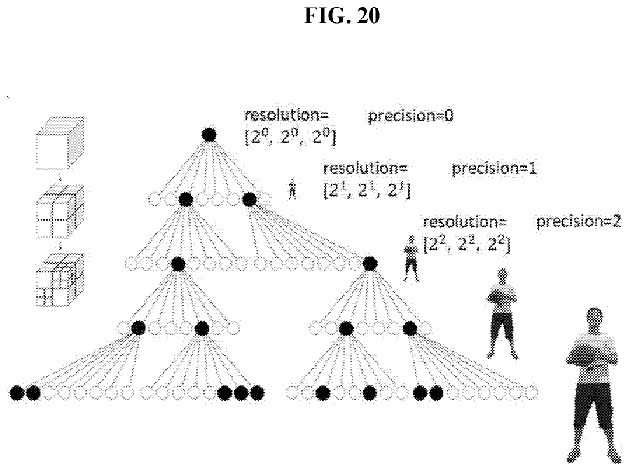

FIG. 20 illustrates the hierarchical structure of geometry information according to precision.

A point cloud may be expressed hierarchically according to precision and may include a plurality of precision levels that represent the same space with a different resolution. As an example, a structure may be represented in which coarse geometry information is expressed at a low precision level and more detailed geometry information is expressed as a precision level increases.

In this way, in a hierarchical structure according to precision, a resolution at each precision level may be set differently and each precision may correspond to a point cloud representation having a different spatial resolution. For example, various precision levels such as precision=0, precision=1, precision=2, precision=10, etc. may be present, and a resolution corresponding to each precision may be defined differently.

As an example, a precision-based hierarchical structure may be expressed in connection with a structure that hierarchically partitions a space, and each precision level may correspond to a level in the hierarchical partitioning structure. In this case, a range in which inter-frame compression is applied up to a specific level may be set.

As an example, in a hierarchical structure, each level may be converted into feature information (feature map) for neural network-based processing, and feature information may be utilized as a latent representation (latent feature) in the form of a tensor and used for an inter-frame or intra-frame compression process.

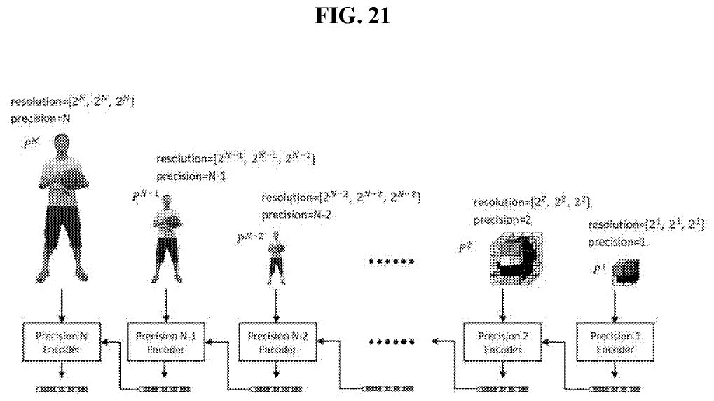

FIG. 21 illustrates the structure of an artificial intelligence-based point cloud encoder.

In FIG. 21, P^{N-k} may refer to the geometry information of precision N−k.

Artificial Intelligence (AI)-based point cloud compression may have a structure that hierarchically compresses and restores the geometry information of an input point cloud according to precision. As an example, the compression structure may be constructed based on a Hierarchical Variational Autoencoder structure, an encoder may be composed of a plurality of layers, and each layer may be constructed to process the geometry information of different precision.

Specifically, an encoder operates hierarchically, and an individual layer may perform compression by receiving as an input the geometry information of specific precision N−k and a bitstream generated at lower precision N−k−1.

Each layer may downsample input geometry information to convert it into feature information, and the feature information may be generated as a latent representation (latent feature) for neural network-based processing. The latent representation may be converted into a bitstream through arithmetic encoding, etc.

In addition, a scale applied during a downsampling process may be set as a value greater than or equal to 2 as well as 1 and accordingly, geometry information compression at various precision levels may be performed.

As an example, a hierarchical structure may be constructed in connection with an octree-level-based spatial partitioning structure, and each layer may correspond to a specific octree level.

As an example, inter-frame compression may be set to be applied up to a specific octree level, and according to the setting, inter-frame prediction may be performed at a corresponding level or lower and intra-frame encoding may be performed when the level is exceeded. For example, the setting may be determined by gps_inter_until_octree_level_minus1.

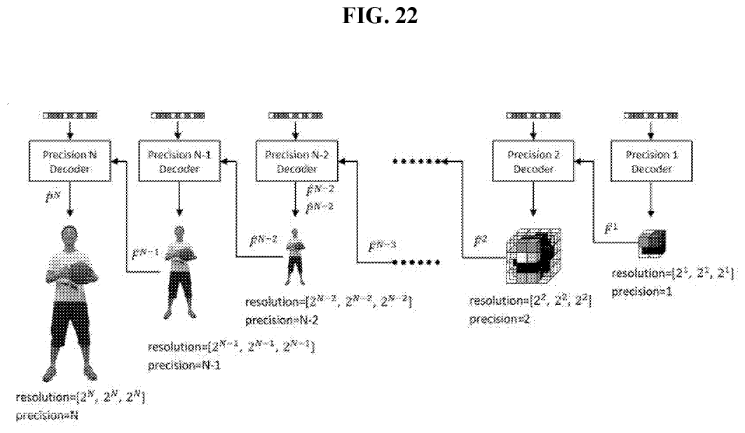

FIG. 22 illustrates the structure of an artificial intelligence-based point cloud decoder.

In FIG. 22, \hat{P}^{N-k} may be the restored geometry information of precision N−k, and \hat{F}^{N-k} may be the restored latent feature information of precision N−k.

An artificial intelligence-based point cloud decoder operates hierarchically according to precision, and each layer may be constructed to sequentially restore the geometry information of corresponding precision.

As an example, the individual layer of a decoder may restore the point cloud information of current precision by receiving as an input the bitstream of specific precision N−k and feature information restored at lower precision N−k−1.

At each layer, an input bitstream may be inversely arithmetic-decoded and based on this, a latent representation (latent feature) may be restored through a neural network. Subsequently, the geometry information of corresponding precision may be restored by using the latent representation.

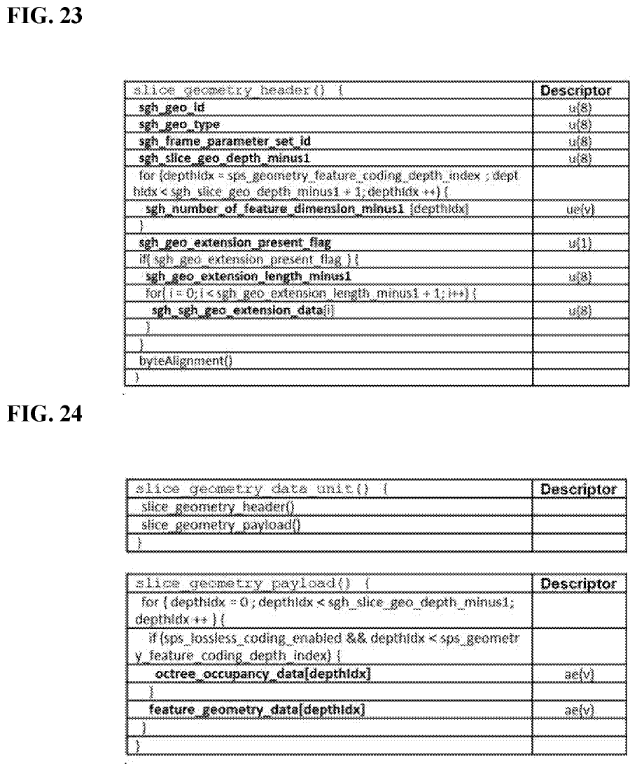

FIGS. 23 and 24 illustrate an example of a bitstream structure and a high-level syntax of point cloud geometry data.

In artificial intelligence-based point cloud compression, an encoder and a decoder operate hierarchically according to precision, and may perform compression in order from lower precision to higher precision. Due to this structure, artificial intelligence-based point cloud compression may separate the amount of information of an input point cloud according to precision and perform efficient compression by predicting the information of higher precision with the information of lower precision. In addition, since the lower precision and higher precision of artificial intelligence-based point cloud compression are independently arithmetic encoded, they may be decoded independently even during decoding.

However, since a current artificial intelligence-based point cloud compression structure has no high-level syntax for individually processing a bitstream corresponding to individual precision, a decoder may restore the bitstream of all precisions only sequentially. When a high-level syntax supports hierarchical decoding according to precision, it may support a decoding method such as hierarchical precision adaptive compression, scalable encoding/decoding (scalable coding), etc.

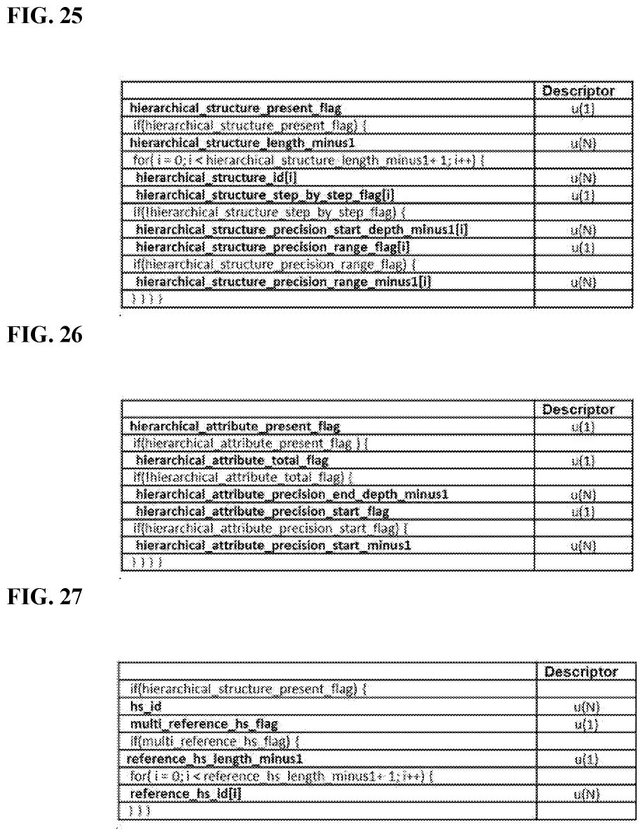

FIG. 25 illustrates an example of a hierarchical adaptive high-level syntax.

As an embodiment of the present disclosure, information for a precision hierarchical structure may be transmitted to a decoder by using a hierarchical adaptive high-level syntax.

As an example, the hierarchical adaptive high-level syntax may include hierarchical_structure_present_flag, and the hierarchical_structure_present_flag may represent whether a hierarchical adaptive high-level syntax is used.

When the hierarchical_structure_present_flag is 1, the number of hierarchical structures may be represented through hierarchical_structure_length_minus1.

In addition, hierarchical_structure_id may be defined for each layer, and each layer may be identified through the hierarchical_structure_id.

In addition, hierarchical_structure_step_by_step_flag may represent the expression method of precision expressed by each layer.

As an example, when hierarchical_structure_step_by_step_flag is 1, each layer may be constructed to correspond to one precision value, and hierarchical_structure_id may be used as a precision value. In addition, when hierarchical_structure_step_by_step_flag is 0, each layer may be constructed to express one or more precision ranges.

In this case, the starting precision of a corresponding layer may be defined through hierarchical_structure_precision_start_depth_minus1.

In addition, hierarchical_structure_precision_range_flag may represent whether a corresponding layer expresses a plurality of precisions.

When the hierarchical_structure_precision_range_flag is 1, the range of precision expressed by a corresponding layer may be defined through hierarchical_structure_precision_range_minus1.

In this case, the maximum precision value expressed by a corresponding layer may be determined by adding up a value obtained by adding 1 to hierarchical_structure_precision_start_depth_minus1 and a value obtained by adding 1 to hierarchical_structure_precision_range_minus1.

In addition, a precision range and a hierarchical structure expressed by each layer may be transmitted to a decoder through the hierarchical adaptive high-level syntax.

In addition, the number of the hierarchical structures may be expressed through layer number information, and precision handled by each layer may be determined by using information representing the last precision of each layer.

FIG. 26 illustrates an example of a hierarchical adaptive high-level syntax for attribute data.

As an embodiment of the present disclosure, a hierarchical adaptive high-level syntax may include information for defining a hierarchical structure for attribute data.

As an example, hierarchical_attribute_present_flag may represent whether attribute information is used according to a hierarchical adaptive high-level syntax.

When the hierarchical_attribute_present_flag is 1, hierarchical_attribute_total_flag may be used as a flag for setting a precision range in which attribute information is expressed.

As an example, when hierarchical_attribute_total_flag is 1, attribute information may be constructed to be present in all layers, and original attribute information may be obtained only by decoding up to the maximum precision.

In addition, when hierarchical_attribute_total_flag is 0, attribute information may be constructed to obtain original attribute information even when it is restored only up to a specific precision layer.

In addition, hierarchical_attribute_precision_end_depth_minus1 may represent the maximum precision value of attribute information and define the maximum precision at which restored attribute information may be obtained.

As an example, when precision range information is not present separately, original attribute information may be obtained by decoding attribute information for a precision range from the lowest precision to a value obtained by adding 1 to hierarchical_attribute_precision_end_depth_minus1.

In addition, hierarchical_attribute_precision_start_flag may represent whether the starting precision layer of attribute information is the lowest precision.

As an example, when hierarchical_attribute_precision_start_flag is 0, attribute information may need to be decoded starting from the lowest precision.

In addition, hierarchical_attribute_precision_start_minus1 may represent precision at which attribute information starts, and a value obtained by adding 1 to the hierarchical_attribute_precision_start_minus1 may refer to precision at which attribute information starts.

In addition, a precision range in which attribute information is expressed may be determined through a difference between a value obtained by adding 1 to hierarchical_attribute_precision_end_depth_minus1 and a value obtained by adding 1 to hierarchical_attribute_precision_start_minus1.

In addition, the precision range and hierarchical structure of attribute data may be transmitted to a decoder through the hierarchical adaptive high-level syntax.

In addition, a hierarchical structure for attribute data may be defined in connection with or independently of the hierarchical structure of geometry data.

FIG. 27 illustrates an example of hierarchical index information for transmitting a hierarchical structure.

As an embodiment of the present disclosure, when a hierarchical adaptive high-level syntax is used, hierarchical index information corresponding to each layer may be included in a bitstream and transmitted to a decoder.

As an example, hierarchical index information may be stored in each layer to transmit a hierarchical structure. The hierarchical index information may be transmitted per slice or may be transmitted per sub-slice which is the sub-unit of a slice structure. In addition, a separate new structure may be defined to transmit a hierarchical structure.

As an example, hs_id is information in which the value of hierarchical_structure_id is stored in a data unit header, and may represent a precision range or precision expressed by a corresponding data unit.

In addition, multi_reference_hs_flag may be a flag representing whether a plurality of reference layers are present for decoding a current layer stream.

As an example, when multi_reference_hs_flag is 1, a reference layer identifier may be transmitted together, and when multi_reference_hs_flag is 0, only the lower layer may be used as a reference layer.

In addition, reference_hs_length_minus1 may represent a value obtained by subtracting 1 from the number of reference layers used to decode a current layer stream.

In addition, reference_hs_id may represent the index of a reference layer, and a current layer may be constructed to refer to a plurality of reference layers by using a plurality of reference_hs_ids.

Accordingly, a decoder may interpret a precision range or precision expressed by a current layer by using hs_id, multi_reference_hs_flag, reference_hs_length_minus1 and reference_hs_id, and may determine a reference layer required for decoding a current layer.

In addition, the hierarchical index information and reference layer information may be signaled at a data unit header level, thereby supporting hierarchical selective decoding or decoding based on a plurality of reference layers.

As an embodiment of the present disclosure, parameters required for whether to use a hierarchical adaptive high-level syntax defined in previous steps and the use of a technology may be stored in various ways according to a bitstream structure.

As an example, information for identifying whether to use a hierarchical adaptive high-level syntax may be recorded in at least one of a Sequence parameter set, a Frame parameter set, a Geometry parameter set, a Geometry data unit, an Attribute parameter set or an Attribute data unit and stored and transmitted.

In addition, parameters for defining a hierarchical structure, e.g., hierarchical_structure_present_flag, hierarchical_structure_length_minus1, hierarchical_structure_id, hierarchical_structure_precision_start_depth_minus1, hierarchical_structure_precision_range_minus1, etc., may be recorded within a bitstream structure as described above.

In addition, parameters for defining a hierarchical structure for attribute data, e.g., hierarchical_attribute_present_flag, hierarchical_attribute_total_flag, hierarchical_attribute_precision_end_depth_minus1, hierarchical_attribute_precision_start_minus1, etc., may also be recorded within a bitstream structure.

In addition, parameters for defining an inter-layer reference relationship, e.g., hs_id, multi_reference_hs_flag, reference_hs_length_minus1 and reference_hs_id, may also be recorded within a bitstream structure and stored and transmitted.

In addition, the parameters may be generated during an encoding process and included in a bitstream, and may be referenced during a decoding process to determine a decoding method according to a hierarchical structure.

In addition, the parameters may be selectively signaled in various data units or layers within a bitstream, and accordingly, selective decoding in a layer unit or a precision unit may be possible.

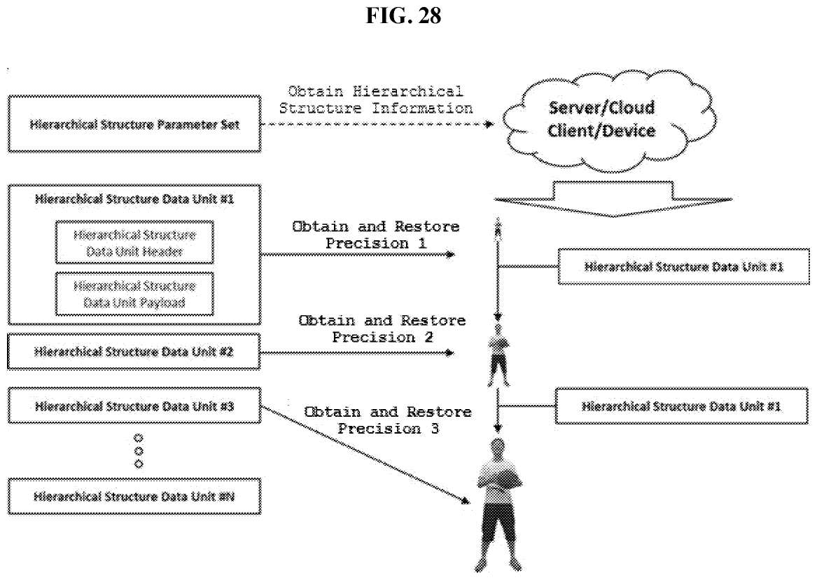

FIG. 28 illustrates an example of scalable compression using a hierarchical adaptive high-level syntax.

As an embodiment of the present disclosure, scalable compression or hierarchical attribute compression may be performed by using a hierarchical adaptive high-level syntax.

As an example, a server or a client may receive hierarchical structure information as an input to obtain precision information and attribute information corresponding to each layer.

In addition, a bitstream constructed based on a hierarchical structure may be constructed by being separated into a plurality of hierarchical unit data, and each layer may be expressed in the form of a Hierarchical Structure Data Unit.

As an example, a Hierarchical Structure Data Unit may include header information and payload information, and the header information may include hierarchical identification information.

In addition, a decoder may selectively obtain and decode the data unit of a specific layer based on the hierarchical structure information and may selectively access and decode a plurality of layers according to a service environment.

As an example, fast decoding may be performed by using only the data of a low-precision layer or more precise decoding may be performed by including up to a high-precision layer.

In addition, a bitstream corresponding to each layer may be selectively accessed according to the demand of a service application and accordingly, hierarchical adaptive decoding may be performed.

In addition, the hierarchical structure information may be utilized as control information for determining the access and decoding order of hierarchical data units.

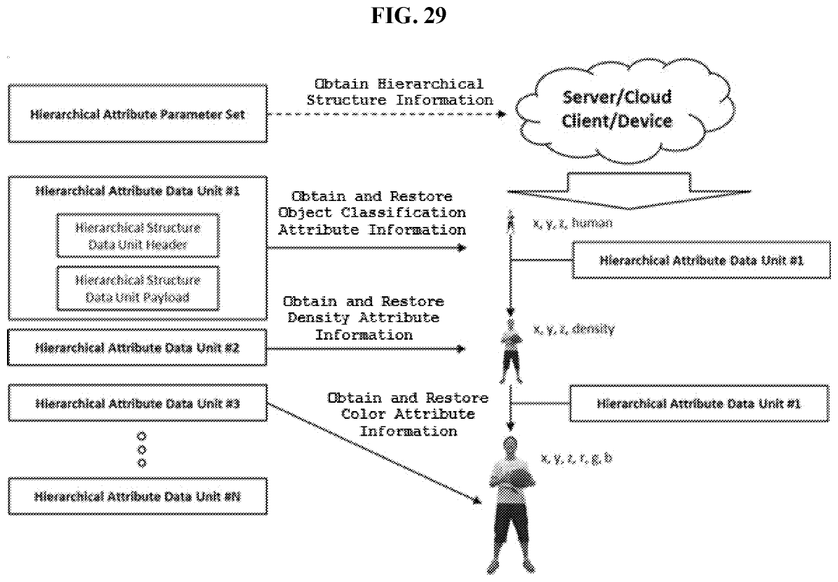

FIG. 29 illustrates an example of attribute data-based scalable compression using a hierarchical adaptive high-level syntax.

As an embodiment of the present disclosure, scalable compression or hierarchical attribute compression for attribute data may be performed by using a hierarchical adaptive high-level syntax.

As an example, a server or a client may receive hierarchical structure information as an input to obtain attribute information corresponding to each layer.

In addition, an attribute data bitstream constructed based on a hierarchical structure may be constructed by being separated into a plurality of hierarchical unit data, and each layer may be expressed in the form of a Hierarchical Attribute Data Unit.

As an example, a Hierarchical Attribute Data Unit may include header information and payload information, and the header information may include hierarchical identification information or attribute information.

In addition, each layer may be constructed to express different attribute information.

As an example, a specific layer may include attribute information related to object classification, another layer may include attribute information related to density and another layer may include attribute information related to a color (r, g, b).

In addition, a decoder may selectively obtain and decode the data unit of a specific attribute layer based on the hierarchical structure information and may selectively restore only necessary attribute information according to a service environment.

As an example, when only object classification information is used, only a corresponding layer may be decoded, and when density information or color information is required, a corresponding layer may be additionally decoded.

In addition, attribute data corresponding to each layer may be selectively accessed according to the demand of a service application and accordingly, attribute-based hierarchical adaptive decoding may be performed.

In addition, the attribute hierarchical structure may be constructed independently of or in connection with a geometry hierarchical structure, thereby supporting various forms of attribute-based scalable decoding.

As an embodiment of the present disclosure, a function such as scalable compression or hierarchical attribute compression, etc. may be applied by using a hierarchical adaptive high-level syntax.

As an example, by adaptively applying a compression technology to each layer by using a proposed technology, optimal compression efficiency suitable for an individual layer may be obtained.

In addition, a parameter required for decoding a compression technology applied to each layer may be transmitted along with a hierarchical structure index and through this, a decoder may perform decoding by applying a different compression technology for each layer.

In addition, a different compression technology may be applied according to a hierarchical structure, thereby securing differentiated compression performance for each layer.

In addition, the hierarchical structure may be applied to various service environments that encode or decode a bitstream according to a hierarchical structure.

In addition, the hierarchical structure may be used to selectively utilize a layer or apply a different compression method according to a service need, thereby supporting various forms of scalable encoding and decoding.

Although the exemplary methods of the present disclosure are expressed as a series of operations for clarity of description, this is not intended to limit the order in which steps are performed, and if necessary, each step may be performed simultaneously or in different order. In order to implement a method according to the present disclosure, another step may be additionally included in an exemplary step or the remaining steps may be included excluding some steps or another additional step may be included excluding some steps.

The various embodiments of the present disclosure do not list all possible combinations, but are intended to describe the representative aspect of the present disclosure, and matters described in various embodiments may be applied independently or in a combination of at least two.

In addition, the various embodiments of the present disclosure may be implemented by hardware, firmware, software or a combination thereof. For implementation by hardware, they may be implemented by one or more ASICs (Application Specific Integrated Circuits), DSPs (Digital Signal Processors), DSPDs (Digital Signal Processing Devices), PLDs (Programmable Logic Devices), FPGAs (Field Programmable Gate Arrays), general processors, controllers, microcontrollers, microprocessors, etc.

The range of the present disclosure includes software or machine-executable instructions (i.e., an operating system, an application, firmware, a program, etc.) that enable operations according to the methods of various embodiments to be executed on a device or computer, and a non-transitory computer-readable medium in which such software or instructions are stored and executable on a device or computer.

1. A point cloud data decoding method, comprising:
obtaining a bitstream;
obtaining hierarchical structure information from the bitstream; and
based on the hierarchical structure information, performing decoding on at least one of a precision layer or an attribute layer.

2. The method of claim 1, wherein:
the hierarchical structure information includes information indicating a number of layers and information representing a last precision of each layer.

3. The method of claim 2, wherein:
the hierarchical structure information further includes information representing a starting precision and a precision range.

4. The method of claim 2, wherein:
each layer included in the hierarchical structure information is constructed to correspond to one precision or express a plurality of precision ranges.

5. The method of claim 1, wherein:
the hierarchical structure information further includes hierarchical structure information for attribute data.

6. The method of claim 5, wherein:
the hierarchical structure information for the attribute data includes information representing whether attribute information is present in all precision layers or is present only up to a specific precision layer.

7. The method of claim 5, wherein:
the hierarchical structure information for the attribute data includes information representing a maximum precision and a starting precision of attribute information.

8. The method of claim 1, wherein:
the hierarchical structure information includes hierarchical index information corresponding to each layer.

9. The method of claim 8, wherein:
the hierarchical index information includes identification information of a reference layer.

10. The method of claim 1, wherein:
the decoding step is performed for a portion of all layers.

11. The method of claim 5, wherein:
the decoding step is performed for a specific attribute layer.

12. The method of claim 1, wherein:
the hierarchical structure information is included in a data unit header of the bitstream and transmitted.

13. The method of claim 2, wherein:
the hierarchical structure information is constructed to enable the decoding sequentially according to a hierarchical precision.

14. A point cloud data encoding method, comprising:
partitioning point cloud data into a plurality of layers;
generating hierarchical structure information including information indicating a number of layers and information indicating a last precision of each layer; and
generating a bitstream by encoding data of each layer along with the hierarchical structure information.

15. A non-transitory computer readable recording medium for storing a bitstream generated by a point cloud data encoding method, comprising:
partitioning point cloud data into a plurality of layers;
generating hierarchical structure information including information indicating a number of layers and information indicating a last precision of each layer; and
generating a bitstream by encoding data of each layer along with the hierarchical structure information.
